(19) United States
(12) Patent Application Publication
(10) Pub. No.: US 2024/0235763 A1
(43) Pub. Date: Jul. 11, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/614,773

(22) Filed: Mar. 25, 2024

Related U.S. Application Data
(63) Continuation of application No. PCT/CN2022/119621, filed on Sep. 19, 2022.

(30) Foreign Application Priority Data
Sep. 26, 2021 (CN) 202111127816.7

(51) Int. Cl. H04L 5/00

(52) U.S. Cl. CPC H04L 5/0048

(57) ABSTRACT

Present application provides a method and a device in a communication node for wireless communications. A communication node receives a first signaling, the first signaling indicates a first RS resource set which comprises at least one RS resource group, and each RS resource group comprises at least one RS resource subgroup; determines whether to trigger a BFR based on whether a first-type counter reaches a first-type value; receives a second signaling which indicates a first uplink grant; determines a format of a target MAC CE based on a number of RS resource subgroup(s) indicated by each of at least one candidate format in a first candidate format set, and an RS resource subgroup indicated by any candidate format belongs to the first RS resource set; transmits the target MAC CE according to the first uplink grant; each candidate format is a format of a MAC CE indicating BFR.

### CROSS REFERENCE TO RELATED APPLICATIONS

This application is the continuation of the international patent application No. PCT/CN2022/119621, filed on Sep. 19,2022, and claims the priority benefit of Chinese Patent application Ser. No. 20/211,1127816.7, filed on Sep. 26,2021, the full disclosure of which is incorporated herein by reference.

### BACKGROUND

### Technical Field

The present application relates to transmission methods and devices in wireless communication systems, and in particular to a multi-beam related transmission method and device.

### Related Art

The 3rd Generation Partnership Project (3GPP) introduced a Beam Failure Recovery (BFR) mechanism for a Special Cell (SpCell) in Release 15 (R15), and introduced a BFR mechanism for a Secondary

Cell (SCell) in R16. Through the BFR mechanism, triggering higher-layer Radio Link Failure (RLF) can be avoided. 3GPP Radio Access Network (RAN) #80-th meeting decided to carry out a Work Item (WI) of “Further enhancements on Multiple Input Multiple Output (MIMO) for New Radio (NR)” to enhance the BFR mechanism for Multiple Transmitter and Receiver Point (multi-TRP).

### SUMMARY

A BFR MAC CE of R16 comprises a bitmap used for indicating a cell (Ci field) in which beam failure occurred, and for each SCell in which beam failure occurs, a byte used for indicating beam failure information may also be comprised, the byte comprises an AC (availability indication) field, the AC field indicating whether a Candidate Reference Signal (RS) ID field exists, the Candidate RS ID field is used to indicate a Candidate RS ID when it exists, and a bit corresponding to a candidate RS ID field is reserved when the candidate RS ID field does not exist. Due to R17 (Release 17) enhancing the BFR mechanism for multiple TRPs, each TRP independently performs beam failure detection and recovery processes, and each TRP is configured with a reference signal resource set used for beam failure detection and a corresponding candidate reference signal resource set, resulting in enhancements to the MAC (Media Access Control) CE (Control Element) used for BFR and enhancements to the selection of different MAC CE types.

To address the above problem, the present application provides a solution. It should be noted that though the present application only took the Uu interface scenario for example in the statement above; the present application is also applicable to scenarios such as sidelink, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource;
for each RS resource subgroup in the first RS resource set, whenever radio link quality assessed based on the each RS resource subgroup is worse than a first-type threshold, increasing a first-type counter corresponding to the each RS resource subgroup by 1; determining whether to trigger a BFR based on whether the first-type counter corresponding to the each RS resource subgroup reaches a first-type value;
receiving a second signaling, the second signaling indicating a first uplink grant; and
determining a format of a target MAC CE based on a number of RS resource subgroup(s) indicated by each of at least one candidate format in a first candidate format set, an RS resource subgroup indicated by any of the at least one candidate format in the first candidate format set being an RS resource subgroup in the first RS resource set; transmitting the target MAC CE according to an instruction of the first uplink grant;
herein, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, a problem to be solved in the present application comprises: how to determine a format of a target MAC CE among multiple candidate MAC CE formats.

In one embodiment, a problem to be solved in the present application comprises: determining a format of a target MAC CE based on which parameter.

In one embodiment, characteristics of the above method comprise: an RS resource group comprises at least one RS resource subgroup.

In one embodiment, characteristics of the above method comprise: comprising two RS resource subgroups in at least one RS resource group in the first RS resource set.

In one embodiment, characteristics of the above method comprise: a number of RS resource subgroup(s) indicated by each candidate format in the at least one candidate format in the first candidate format set does not exceed a number of RS resource subgroup(s) in the first RS resource set.

In one embodiment, characteristics of the above method comprise: a number of RS resource subgroup(s) indicated by each candidate format in the at least one candidate format in the first candidate format set is equal to a number of RS resource subgroup(s) in the first RS resource set.

In one embodiment, characteristics of the above method comprise: a number of RS resource subgroup(s) indicated by each candidate format in the at least one candidate format in the first candidate format set is less than a number of RS resource subgroup(s) in the first RS resource set.

In one embodiment, characteristics of the above method comprise: a number of RS resource subgroup(s) indicated by each candidate format in the at least one candidate format in the first candidate format set is related to a bitmap in the each candidate format.

In one embodiment, characteristics of the above method comprise: a number of RS resource subgroup(s) indicated by each candidate format in the at least one candidate format in the first candidate format set is related to a largest cell identity of a cell associated with each RS resource subgroup in the first RS resource set.

In one embodiment, advantages of the above method comprise: selecting an appropriate MAC CE format used for BFR.

In one embodiment, advantages of the above method comprise: improving the validity of BFR information.

In one embodiment, advantages of the above method comprise: a target MAC CE indicates as many RS resource subgroups with BFR as possible.

In one embodiment, advantages of the above method comprise: a target MAC CE tries to indicate BFR information of an RS resource subgroup with higher priority.

According to one aspect of the present application, it is characterized in that under the condition of not exceeding a size of resources granted by the first uplink grant, the format of the target MAC CE is a candidate format containing a largest amount of BFR information in the at least one candidate format in the first candidate format set.

In one embodiment, characteristics of the above method comprise: the target MAC CE indicates as much BFR information as possible.

In one embodiment, a number of RS resource subgroup(s) indicated by any of the at least one candidate format in the first candidate format set is used to determine the amount of BFR information contained by the any candidate format.

In one embodiment, a number of BFR(s) that can be contained by the resources granted by the first uplink grant is used to determine the amount of BFR information contained by the any candidate format.

In one embodiment, an amount of BFR information in the first RS resource set is used to determine the amount of BFR information contained by the any candidate format.

In one embodiment, a number of BFR(s) that can be contained by the resources granted by the first uplink grant and an amount of BFR information in the first RS resource set are used together to determine the amount of BFR information contained by the any candidate format.

According to one aspect of the present application, it is characterized in that under the condition of not exceeding a size of resources granted by the first uplink grant, amounts of BFR information contained by at least two candidate formats in the at least one candidate format in the first candidate format set are tied for largest; the format of the target MAC CE is a candidate format with a largest number of RS resource subgroup(s) indicated in the at least two candidate formats.

In one embodiment, a number of RS resource subgroup(s) indicated by any of the at least one candidate format in the first candidate format set is used to determine the amount of BFR information contained by the any candidate format.

In one embodiment, a number of BFR(s) that can be contained by the resources granted by the first uplink grant is used to determine the amount of BFR information contained by the any candidate format.

In one embodiment, an amount of BFR information in the first RS resource set is used to determine the amount of BFR information contained by the any candidate format.

In one embodiment, a number of BFR(s) that can be contained by the resources granted by the first uplink grant and an amount of BFR information in the first RS resource set are used together to determine the amount of BFR information contained by the any candidate format.

According to one aspect of the present application, it is characterized in that under the condition of not exceeding a size of resources granted by the first uplink grant, the format of the target MAC CE is a candidate format occupying a largest number of octet(s) in the at least one candidate format in the first candidate format set, and a number of RS resource subgroup(s) indicated by any of the at least one candidate format in the first candidate format set is used to determine the number of octet(s) occupied by the any candidate format.

In one embodiment, characteristics of the above method comprise: if two RS resource subgroups in an RS resource group in the first RS resource set both have BFR, under the condition of not exceeding a size of resources granted by the first uplink grant, the format of the target MAC CE comprises BFR information for each RS resource subgroup.

In one embodiment, characteristics of the above method comprise: if two RS resource subgroups in an RS resource group in the first RS resource set both have BFR, under the condition of not exceeding a size of resources granted by the first uplink grant, the target MAC CE comprises two bitmaps.

According to one aspect of the present application, it is characterized in that under the condition of not exceeding a size of resources granted by the first uplink grant, numbers of octets occupied by at least two candidate formats in the at least one candidate format in the first candidate format set are tied for largest; the format of the target MAC CE is a candidate format containing a largest amount of BFR information in the at least two candidate formats; a number of RS resource subgroup(s) indicated by any of the at least one candidate format in the first candidate format set is used to determine the number of octet(s) occupied by the any candidate format.

According to one aspect of the present application, it is characterized in that BFR information contained in any of the at least one candidate format in the first candidate format set belongs to first H RS resource subgroup(s) sorted according to a first criterion for RS resource subgroup(s) in the first RS resource set, and the first criterion comprises at least sorting according to a cell identity of an associated cell.

In one embodiment, characteristics of the above method comprise: the first criterion also comprises sorting based on whether an RS resource group to which an RS resource subgroup belongs comprises an RS resource subgroup without BFR.

In one embodiment, characteristics of the above method comprise: the first criterion also comprises sorting based on a number of RS resource subgroup(s) comprised in an RS resource group to which an RS resource subgroup belongs.

In one embodiment, characteristics of the above method comprise: the first criterion also comprises sorting according to a type of an RS resource subgroup in an RS resource group.

In one embodiment, characteristics of the above method comprise: BFR information in the target MAC CE is sorted BFR information.

In one embodiment, characteristics of the above method comprise: the target MAC CE should indicate BFR information with higher priority as much as possible.

In one embodiment, characteristics of the above method comprise: the target MAC CE indicates as much as possible BFR information in an RS resource group in which all RS resource subgroups having BFR.

According to one aspect of the present application, it is characterized in that any RS resource subgroup indicated by the first candidate format is indicated by the second candidate format, and at least one RS resource subgroup having BFR indicated by the second candidate format is not indicated by the first candidate format.

The present application provides a method in a second node for wireless communications, comprising:
transmitting a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource;
transmitting a second signaling, the second signaling indicating a first uplink grant; and
receiving a target MAC CE;
herein, for each RS resource subgroup in the first RS resource set, whenever radio link quality assessed based on the each RS resource subgroup is worse than a first-type threshold, a first-type counter corresponding to the each RS resource subgroup is increased by 1; whether to trigger a BFR is determined based on whether the first-type counter corresponding to the each RS resource subgroup reaches a first-type value; the target MAC CE is transmitted according to the instruction of the first uplink grant; a format of the target MAC CE is determined based on a number of RS resource subgroup(s) indicated by each of at least one candidate format in a first candidate format set, an RS resource subgroup indicated by any of the at least one candidate format in the first candidate format set is an RS resource subgroup in the first RS resource set; the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

According to one aspect of the present application, it is characterized in that under the condition of not exceeding a size of resources granted by the first uplink grant, the format of the target MAC CE is a candidate format containing a largest amount of BFR information in the at least one candidate format in the first candidate format set; a number of RS resource subgroup(s) indicated by any of the at least one candidate format in the first candidate format set is used to determine the amount of BFR information contained by the any candidate format.

According to one aspect of the present application, it is characterized in that under the condition of not exceeding a size of resources granted by the first uplink grant, amounts of BFR information contained by at least two candidate formats in the at least one candidate format in the first candidate format set are tied for largest; the format of the target MAC CE is a candidate format with a largest number of RS resource subgroup(s) indicated in the at least two candidate formats; a number of RS resource subgroup(s) indicated by any of the at least one candidate format in the first candidate format set is used to determine the amount of BFR information contained by the any candidate format.

According to one aspect of the present application, it is characterized in that under the condition of not exceeding a size of resources granted by the first uplink grant, the format of the target MAC CE is a candidate format occupying a largest number of octet(s) in the at least one candidate format in the first candidate format set, and a number of RS resource subgroup(s) indicated by any of the at least one candidate format in the first candidate format set is used to determine the number of octet(s) occupied by the any candidate format.

According to one aspect of the present application, it is characterized in that under the condition of not exceeding a size of resources granted by the first uplink grant, numbers of octets occupied by at least two candidate formats in the at least one candidate format in the first candidate format set are tied for largest; the format of the target MAC CE is a candidate format containing a largest amount of BFR information in the at least two candidate formats; a number of RS resource subgroup(s) indicated by any of the at least one candidate format in the first candidate format set is used to determine the number of octet(s) occupied by the any candidate format.

According to one aspect of the present application, it is characterized in that BFR information contained in any of the at least one candidate format in the first candidate format set belongs to first H RS resource subgroup(s) sorted according to a first criterion for RS resource subgroup(s) in the first RS resource set, and the first criterion comprises at least sorting according to a cell identity of an associated cell.

According to one aspect of the present application, it is characterized in that any RS resource subgroup indicated by the first candidate format is indicated by the second candidate format, and at least one RS resource subgroup having BFR indicated by the second candidate format is not indicated by the first candidate format.

The present application provides a first node for wireless communications, comprising:
a first receiver, receiving a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource; for each RS resource subgroup in the first RS resource set, whenever radio link quality assessed based on the each RS resource subgroup is worse than a first-type threshold, increasing a first-type counter corresponding to the each RS resource subgroup by 1; determining whether to trigger a BFR based on whether the first-type counter corresponding to the each RS resource subgroup reaches a first-type value; receiving a second signaling, the second signaling indicating a first uplink grant; and
a first transmitter, determining a format of a target MAC CE based on a number of RS resource subgroup(s) indicated by each of at least one candidate format in a first candidate format set, an RS resource subgroup indicated by any of the at least one candidate format in the first candidate format set being an RS resource subgroup in the first RS resource set; transmitting the target MAC CE according to an instruction of the first uplink grant;
herein, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

The present application provides a second node for wireless communications, comprising:
a second transmitter, transmitting a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource; transmitting a second signaling, the second signaling indicating a first uplink grant; and
a second receiver, receiving a target MAC CE;
herein, for each RS resource subgroup in the first RS resource set, whenever radio link quality assessed based on the each RS resource subgroup is worse than a first-type threshold, a first-type counter corresponding to the each RS resource subgroup is increased by 1; whether to trigger a BFR is determined based on whether the first-type counter corresponding to the each RS resource subgroup reaches a first-type value; the target MAC CE is transmitted according to the instruction of the first uplink grant; a format of the target MAC CE is determined based on a number of RS resource subgroup(s) indicated by each of at least one candidate format in a first candidate format set, an RS resource subgroup indicated by any of the at least one candidate format in the first candidate format set is an RS resource subgroup in the first RS resource set; the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the present application has the following advantages over conventional schemes:
selecting an appropriate MAC CE format used for BFR;
improving the validity of BFR information;
the target MAC CE indicates as many RS resource subgroups with BFR as possible;
a target MAC CE should indicate BFR information of an RS resource subgroup with higher priority as much as possible.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first signaling, a second signaling and a target MAC CE according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a format of a target MAC CE being a candidate format with a largest amount of BFR information contained in at least one candidate format in a first candidate format set according to one embodiment of the present application;

FIG. 7 illustrates a schematic diagram of a format of a target MAC CE being a candidate format with a largest amount of BFR information contained in at least one candidate format in a first candidate format set according to another embodiment of the present application;

FIG. 8 illustrates a schematic diagram of a format of a target MAC CE being a candidate format with a largest number of octet(s) occupied in at least one candidate format in a first candidate format set according to one embodiment of the present application;

FIG. 9 illustrates a schematic diagram of a format of a target MAC CE being a candidate format with a largest number of octet(s) occupied in at least one candidate format in a first candidate format set according to another embodiment of the present application;

FIG. 10 illustrates a schematic diagram of RS resource subgroup(s) indicated by one candidate format belonging to first H RS resource subgroup(s) sorted according to a first criterion for RS resource subgroup(s) in the first RS resource set according to one embodiment of the present application;

FIG. 11 illustrates a schematic diagram of a first bitmap according to one embodiment of the present application;

FIG. 12 illustrates a schematic diagram of a second bitmap and a third bitmap according to one embodiment of the present application;

FIG. 13 illustrates a schematic diagram of BFR information according to one embodiment of the present application;

FIG. 14 illustrates a schematic diagram of a format of a target MAC CE according to one embodiment of the present application;

FIG. 15 illustrates a schematic diagram of any RS resource subgroup indicated by a first candidate format being indicated by a second candidate format according to one embodiment of the present application;

FIG. 16 illustrates a schematic diagram of a first field in a MAC sub-header indicating whether a target MAC CE comprises a third bitmap according to one embodiment of present application;

FIG. 17 illustrates a schematic diagram of a second bitmap being used to determine a size of a third bitmap according to one embodiment of the present application;

FIG. 18 illustrates a structure block diagram of a processor in a first node according to one embodiment of the present application;

FIG. 19 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

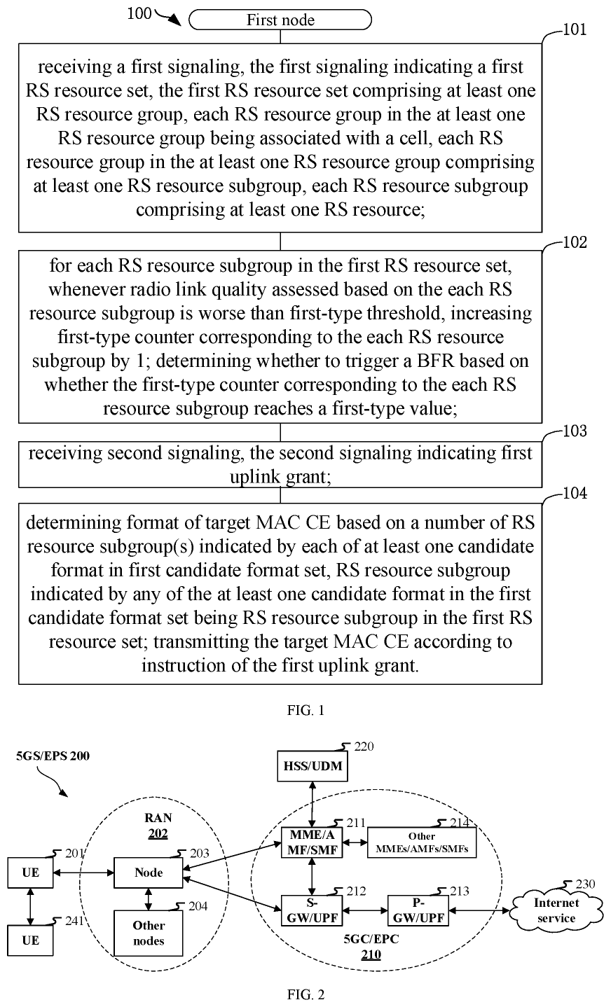

Embodiment 1 illustrates a flowchart of transmission of a first signaling, a second signaling and a target MAC CE according to one embodiment of the present application, as shown in FIG. 1. In FIG. 1, each step represents a step, it should be particularly noted that the sequence order of each box herein does not imply a chronological order of steps marked respectively by these boxes.

In embodiment 1, the first node in the present application in step 101 receives a first signaling, the first signaling indicates a first RS resource set, the first RS resource set comprises at least one RS resource group, each RS resource group in the at least one RS resource group is associated with a cell, each RS resource group in the at least one RS resource group comprises at least one RS resource subgroup, each RS resource subgroup comprises at least one RS resource; in step 102, for each RS resource subgroup in the first RS resource set, whenever radio link quality assessed based on the each RS resource subgroup is worse than a first-type threshold, increases a first-type counter corresponding to the each RS resource subgroup by 1; determines whether to trigger a BFR based on whether the first-type counter corresponding to the each RS resource subgroup reaches a first-type value; in step 103, receives a second signaling, the second signaling indicates a first uplink grant; in step 104, determines a format of the target MAC CE based on a number of RS resource subgroup(s) indicated by each of at least one candidate format in a first candidate format set, an RS resource subgroup indicated by any of the at least one candidate format in the first candidate format set is an RS resource subgroup in the first RS resource set; transmits the target MAC CE according to an instruction of the first uplink grant; herein, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the index of each RS resource in the first RS resource set is obtained directly or indirectly based on the first signaling.

In one embodiment, each RS resource in each RS resource subgroup in each RS resource group in the first RS resource set is determined based on the first signaling.

In one embodiment, an index of each RS resource in each RS resource subgroup in each RS resource group in the first RS resource set is determined based on the first signaling.

In one embodiment, the first signaling is used to configure RS resources in each RS resource subgroup of each RS resource group in the first RS resource set.

In one embodiment, the first signaling is used to configure the first RS resource set.

In one embodiment, the first signaling is used to determine the first RS resource set.

In one embodiment, the first signaling implicitly indicates the first RS resource set.

In one embodiment, the first signaling explicitly indicates the first RS resource set.

In one embodiment, the first signaling is used to determine an index of each RS resource in the first RS resource set.

In one embodiment, the first signaling indicates an index of each RS resource in the first RS resource set.

In one embodiment, the first signaling comprises a Downlink (DL) signaling.

In one embodiment, the first signaling comprises a sidelink signaling.

In one embodiment, the first signaling is an RRC message.

In one embodiment, the first signaling comprises at least one RRC message.

In one embodiment, the first signaling comprises at least one IE in an RRC message.

In one embodiment, the first signaling comprises at least one field in an RRC message.

In one embodiment, the first signaling comprises an RRCReconfiguration message.

In one embodiment, the first signaling comprises a System Information Block 1 (SIB1) message.

In one embodiment, the first signaling comprises a SystemInformation message.

In one embodiment, the first signaling is a field or an IE other than an IE RadioLinkMonitoringConfig.

In one embodiment, the first signaling comprises at least one IE other than an IE RadioLinkMonitoringConfig.

In one embodiment, the first signaling comprises M subsignaling(s), and each sub-signaling comprises an IE RadioLinkMonitoringConfig, M being a number of Bandwidth Part(s) (BWP(s)).

In one embodiment, the first signaling comprises at least one IE RadioLinkMonitoringConfig.

In one embodiment, the first signaling comprises at least one failureDetectionResourcesToAddModList field.

In one embodiment, the first signaling comprises a failureDetectionResourcesToAddModList field.

In one embodiment, at least one IE or at least one field other than an IE RadioLinkMonitoringConfig in the first signaling indicates the first RS resource set.

In one embodiment, the first RS resource set belongs to the first cell group.

In one embodiment, the first cell group is an MCG (Master Cell Group).

In one embodiment, the first cell group is an SCG (Secondary Cell Group).

In one embodiment, the cell is a serving cell in the first cell group, and the serving cell comprises an SpCell (Special Cell) or an SCell (Special Cell).

In one embodiment, the SpCell refers to either a PCell (Primary Cell) or a PSCell (Primary Secondary Cell Group (SCG) Cell).

In one embodiment, the cell is an SCell.

In one embodiment, the cell is identified by ServCellIndex.

In one embodiment, ServCellIndex of the cell is an integer not less than 1 and not greater than 31.

In one embodiment, the first RS resource set comprises one or multiple RS resource groups.

In one embodiment, each RS resource group in the first RS resource set comprises at least one RS resource subgroup having BFR.

In one embodiment, each RS resource subgroup in the first RS resource set is an RS resource subgroup having BFR.

In one embodiment, the first RS resource set does not comprise an RS resource group associated with an SpCell.

In one embodiment, the first RS resource set does not comprise an RS resource sub-group associated with an SpCell.

In one embodiment, the first RS resource set comprises an RS resource group associated with an SpCell.

In one embodiment, the first RS resource set comprises an RS resource sub-group associated with an SpCell.

In one embodiment, if at least one RS resource subgroup in an RS resource group has BFR, the RS resource group is an RS resource group with BFR.

In one embodiment, a number of RS resource group(s) in the first RS resource set is not greater than a number of all cell(s) in the first cell group.

In one embodiment, a number of RS resource group(s) in the first RS resource set is not greater than a number of all SCell(s) in the first cell group.

In one embodiment, each RS resource group in the first RS resource set belongs to an SCell in the first cell group.

In one embodiment, each RS resource group in the first RS resource set is configured for an SCell in the first cell group.

In one embodiment, each RS resource group in the first RS resource set is associated with an SCell in the first cell group.

In one embodiment, each RS resource group in the first RS resource set belongs to a serving cell in the first cell group.

In one embodiment, each RS resource group in the first RS resource set is configured for a serving cell in the first cell group.

In one embodiment, each RS resource group in the first RS resource set is associated with a serving cell in the first cell group.

In one embodiment, an RS resource group corresponds to a cell.

In one embodiment, each RS resource subgroup in an RS resource group is associated with a same cell.

In one embodiment, each RS resource subgroup in an RS resource group is associated with a same cell.

In one embodiment, each RS resource in each RS resource subgroup in an RS resource group is associated with a same cell.

In one embodiment, any two RS resource groups in the at least one RS resource group belong to two different cells.

In one embodiment, a cell to which an RS resource group in the at least one RS resource group is associated and a cell to which another RS resource group is associated have different ServCellIndex.

In one embodiment, a cell to which an RS resource group in the at least one RS resource group is associated and a cell to which another RS resource group is associated have different SCellIndex.

In one embodiment, an RS resource group comprises at least one RS resource subgroup.

In one embodiment, an RS resource group comprises one RS resource subgroup or two RS resource subgroups

In one embodiment, an RS resource group comprises two RS resource subgroups.

In one embodiment, a number of RS resource subgroup(s) having BFR in the first RS resource set is equal to M1, and a number of RS resource group(s) comprising at least one RS resource subgroup having BFR in the first RS resource set is equal to M2, M1 is a positive integer, and M2 is a positive integer not greater than the M1.

In one embodiment, among the M2 RS resource group(s) comprising at least one RS resource subgroup having BFR, there exists at least one RS resource group comprising at least two RS resource subgroups.

In one embodiment, one RS resource group comprising at least two RS resource subgroups comprises: one RS resource group only comprising two RS resource subgroups.

In one embodiment, one RS resource group comprising at least two RS resource subgroups comprises: one RS resource group comprising more than two RS resource subgroups.

In one embodiment, one RS resource group comprising at least two RS resource subgroups comprises: one RS resource group comprising two or more than two RS resource subgroups.

In one embodiment, a number of RS resource subgroup(s) comprised in each RS resource group in the first RS resource set is configurable.

In one embodiment, a number of RS resource subgroup(s) comprised in each RS resource group in the first RS resource set is pre-configured.

In one embodiment, numbers of RS resource subgroups comprised in any two RS resource groups in the first RS resource set are equal.

In one embodiment, numbers of RS resource subgroups comprised in any two RS resource groups in the first RS resource set are equal or not equal.

In one embodiment, all RS resources comprised in an RS resource subgroup belong to a same TRP.

In one embodiment, at least one RS resource comprised in an RS resource subgroup is used for link recovery procedure.

In one embodiment, at least one RS resource comprised in an RS resource subgroup is used to determine whether beam failure occurs.

In one embodiment, at least one RS resource comprised in an RS resource subgroup is used for beam failure detection.

In one embodiment, an RS resource subgroup is used for link recovery procedures.

In one embodiment, at least one RS resource comprised in an RS resource subgroup corresponds to one q̅₀.

In one embodiment, an RS resource subgroup corresponds to q̅₀.

In one embodiment, an RS resource subgroup is q̅₀.

In one embodiment, a name of an RS resource subgroup comprises q̅₀.

In one embodiment, an RS resource subgroup is determined through either FailureDetectionResources or beamFailureDetectionResourceList.

In one embodiment, an RS resource subgroup is determined based on a reference signal set indicated in a TCI (Transmission Configuration Indicator) state corresponding to a CORESET (Control resource set) used to monitor a PDCCH (Physical Downlink Control Channel).

In one embodiment, an RS resource subgroup is determined by the first node.

In one embodiment, if two RS resource subgroups belong to a same RS resource group, the two RS resource subgroups belong to a same BWP (Bandwidth Part).

In one embodiment, if two RS resource subgroups belong to a same RS resource group, the two RS resource subgroups belong to an active BWP.

In one embodiment, if two RS resource subgroups belong to a same RS resource group, the two RS resource subgroups belong to a same PCI (Physical Cell Identifier).

In one embodiment, if two RS resource subgroups belong to a same RS resource group, the two RS resource subgroups belong to different PCIs.

In one embodiment, all RS resource subgroups in an RS resource group in the first RS resource set are associated with a same cell.

In one embodiment, there exist two RS resource subgroups in an RS resource group in the first RS resource set being associated with different cells.

In one embodiment, an RS resource is a CSI-RS (Channel State Information Reference Signal) resource.

In one embodiment, an RS resource is an SSB (Synchronization Signal Block) resource.

In one embodiment, an RS resource is an SS (Synchronization Signal)/PBCH (Physical Broadcast Channel) block.

In one embodiment, an RS resource is a CSI-RS resource identified by csi-RS-Index, or the RS resource is an SSB resource identified by ssb-Index.

In one embodiment, an RS resource is a CSI-RS resource identified by csi-RS, or the RS resource is an SSB resource identified by ssb.

In one embodiment, an RS resource is a CSI-RS resource identified by NZP-CSI-RS-ResourceId, or the RS resource is an SSB resource identified by SSB-Index.

In one embodiment, any RS resource in an RS resource subgroup is periodic.

In one embodiment, any RS resource in an RS resource subgroup is aperiodic.

In one embodiment, any RS resource in an RS resource subgroup is QCL (quasi co location)-Type D.

In one embodiment, radio link quality assessed according to an RS resource subgroup being worse than a first-type threshold triggers the first-type counter corresponding to the RS resource subgroup being increased by 1; herein, the RS resource subgroup belongs to the first RS resource set.

In one embodiment, if radio link quality assessed according to an RS resource subgroup is worse than a first-type threshold, the first-type counter corresponding to the RS resource subgroup is increased by 1; if radio link quality assessed according to the RS resource subgroup is not worse than a first-type threshold, the first counter corresponding to the RS resource subgroup is not increased by 1.

In one embodiment, if radio link quality assessed according to an RS resource subgroup is worse than a first-type threshold, the first-type indication is reported to a higher layer, and when the first-type indication is received on the higher layer, the first counter corresponding to the RS resource subgroup is increased by 1.

In one embodiment, if an RS resource subgroup is reconfigured by a higher layer, the first-type counter corresponding to the RS resource subgroup is set to 0.

In one embodiment, if a beam failure recovery timer associated with the first-type counter expires, the first-type counter corresponding to the RS resource subgroup is set to 0.

In one embodiment, the meaning of whenever comprises: once, or as long as, or if, or so long as.

In one embodiment, the phrase that radio link quality assessed according to the each RS resource subgroup is worse than a first-type threshold comprises: radio link quality for all RS resources in each RS resource subgroup is worse than the first-type threshold.

In one embodiment, the phrase that radio link quality assessed according to the each RS resource subgroup is worse than a first-type threshold comprises: radio link quality for each RS resource in each RS resource subgroup is less than the first-type threshold.

In one embodiment, the phrase that radio link quality assessed according to the each RS resource subgroup is worse than a first-type threshold comprises: radio link quality for each RS resource in each RS resource subgroup is greater than the first-type threshold.

In one embodiment, radio link quality is assessed in each first-type assessment period based on an RS resource group.

In one embodiment, the first-type assessment period of the radio link quality comprises at least one slot.

In one embodiment, the slot comprises at least one of slot, or subframe, or radio frame, or frame, or multiple Orthogonal Frequency Division Multiplexing (OFDM) symbols, or multiple Single Carrier Frequency Division Multiple Access (SC-FDMA) symbols.

In one embodiment, the slot comprises a time interval of at least 1 millisecond (ms).

In one embodiment, the evaluation period for the radio link quality is one frame.

In one embodiment, the evaluation period for the radio link quality is one radio frame.

In one embodiment, the first-type threshold is configurable.

In one embodiment, the first-type threshold is pre-configured.

In one embodiment, the first-type threshold is configured through an RRC message.

In one embodiment, the first-type threshold comprises a Block Error Ratio (BLER) threshold.

In one embodiment, the first-type threshold comprises an RSRP (Reference Signal Received Power) threshold.

In one embodiment, the first-type threshold comprises Qₒᵤₜ.

In one embodiment, the first-type threshold is indicated by a field in an RRC message.

In one embodiment, the first-type threshold is indicated by a field in an RRC message, and a name of the field comprises rlmInSyncOutOfSyncThreshold.

In one embodiment, the first-type threshold is indicated by a field in an RRC message, and a name of the field comprises rsrp-ThresholdSSB.

In one embodiment, the first-type threshold is indicated by a field in an RRC message, and a name of the field comprises rsrp-ThresholdBFR.

In one embodiment, whenever radio link quality assessed according to an RS resource subgroup is worse than a first-type threshold, a first-type indication for the RS resource subgroup is reported to a target higher layer in a first-type reporting period corresponding to the first-type assessment period corresponding to the RS resource subgroup.

In one embodiment, the first-type reporting period comprises at least one slot.

In one embodiment, the first-type reporting period is 2 ms.

In one embodiment, the first-type reporting period is 10 ms.

In one embodiment, the first-type reporting period is a shortest period of all RS resources in the RS resource sub-group.

In one embodiment, the behavior of reporting a first-type indication to a target higher layer comprises: the PHY layer of the first node transmits the first-type indication to the target higher layer of the first node through an interlayer interface.

In one embodiment, the behavior of reporting a first-type indication to a target higher layer comprises: transmitting the first-type indication to the target higher layer

In one embodiment, the behavior of reporting a first-type indication to a target higher layer comprises:
informing the first-type indication to the target higher layer.

In one embodiment, the first-type indication is used to indicate beam failure to the target higher layer.

In one embodiment, the first-type indication is a beam failure instance indication.

In one embodiment, whenever radio link quality assessed according to an RS resource subgroup is worse than a first-type threshold, a physical layer of the first node reports to a target higher layer of the first node the first-type indication for the RS resource subgroup, and as a response to the target higher layer of the first node receiving the first-type indication for the RS resource subgroup, the first-type counter corresponding to the RS resource subgroup is increased by 1.

In one embodiment, the behavior of “increasing a first-type counter by 1” comprises: increasing a counter value of the first-type counter by 1.

In one embodiment, the behavior of “increasing a first-type counter by 1” comprises: increment the first-class counter by 1.

In one embodiment, the first-type counter is used to count a number of the first-type indication(s).

In one embodiment, a name of the first-type counter comprises BFI_COUNTER.

In one embodiment, a name of the first-type counter comprises at least one of BFI (Beam Failure Indication), COUNTER, TRP, RS, Set, or per.

In one embodiment, the first-type counter is for a cell.

In one embodiment, the first-type counter is for a TRP in a cell.

In one embodiment, for different RS resource subgroups, there at least exist the first-type thresholds of two RS resource subgroups being configured as different values.

In one embodiment, any two RS resource subgroups in all RS resource subgroups in the first RS resource set are configured with a same first-type threshold.

In one embodiment, there exist two RS resource subgroups in all RS resource subgroups in the first RS resource set being configured with different the first-type thresholds.

In one embodiment, each RS resource subgroup is configured with the first-type threshold.

In one embodiment, each RS resource subgroup is configured with the first-type counter.

In one embodiment, the first-type threshold configured for each RS resource subgroup is configurable.

In one embodiment, any two RS resource subgroups are configured with the same first-type threshold.

In one embodiment, there exist at least two RS resource subgroups being configured with different first-type thresholds.

In one embodiment, two RS resource subgroups within a same RS resource group are configured with the same first-type threshold.

In one embodiment, two RS resource subgroups within a same RS resource group are configured with different first-type thresholds.

In one embodiment, whether a BFR corresponding to the each RS resource subgroup is triggered is determined according to whether the first-type counter corresponding to the each RS resource subgroup reaches a first-type value.

In one embodiment, a first-type counter reaching a first-type value refers to: the first-type counter is equal to or greater than the first-type value.

In one embodiment, a first-type counter reaching a first-type value refers to: the first-type counter is not less than the first-type value.

In one embodiment, if a first-type counter corresponding to an RS resource subgroup reaches a first-type value, a BFR for the RS resource subgroup is triggered; if a first-type counter corresponding to an RS resource subgroup does not reach a first-type value, a BFR for the RS resource subgroup is not triggered.

In one embodiment, only when a first-type counter corresponding to an RS resource subgroup reaches a first-type value, a BFR corresponding to the RS resource subgroup is triggered.

In one embodiment, the first-type value is a positive integer.

In one embodiment, the first-type value is a non-negative integer.

In one embodiment, the first-type value is not greater than 512.

In one embodiment, the first-type value is not greater than 10.

In one embodiment, the first-type value is equal to beamFailureInstanceMaxCount.

In one embodiment, the first-type value is equal to a value of a parameter, and a name of the parameter comprises at least one of beam or Failure or Instance or Max or Count or TRP or RS or Set or per.

In one embodiment, each RS resource subgroup is configured with the first-type value.

In one embodiment, the first-type value configured for each RS resource subgroup is configurable.

In one embodiment, any two RS resource subgroups are configured with the same first-type value.

In one embodiment, there exist at least two RS resource subgroups being configured with different first-type values.

In one embodiment, the second signaling is used to determine the first uplink grant

In one embodiment, the second signaling comprises an RRC messages.

In one embodiment, the second signaling comprises an RRCReconfiguration message.

In one embodiment, the second signaling comprises a System InformationBlock (SIB) message.

In one embodiment, the second signaling comprises at least one IE in an RRC message.

In one embodiment, the second signaling comprises at least one field in an RRC message.

In one embodiment, the second signaling comprises at least one MAC Protocol Data Unit (PDU).

In one embodiment, the second signaling comprises at least one MAC sub-PDU.

In one embodiment, the second signaling comprises at least one MAC sub-header.

In one embodiment, the second signaling comprises at least one MAC RAR.

In one embodiment, the second signaling comprises at least one fallbackRAR.

In one embodiment, the second signaling comprises at least one PDCCH.

In one embodiment, the second signaling comprises at least one DCI.

In one embodiment, the second signaling is obtained by monitoring a C-RNTI of the first node in the first cell group.

In one embodiment, the first uplink grant is an uplink grant.

In one embodiment, the first uplink grant is dynamically scheduled on a PDCCH by the second signaling, and the second signaling comprises a DCI (Downlink control information).

In one embodiment, the first uplink grant is received in a second signaling, and the second signaling comprises a Random Access Response (RAR).

In one embodiment, the first uplink grant is configured semi-persistently by the second signaling, and the second signaling comprises an RRC message.

In one embodiment, the first uplink grant is determined to be associated with the PUSCH (Physical Uplink Shared Channel) resource of MSGA, and the PUSCH of the MSGA is configured by the second signaling.

In one embodiment, a format of a target MAC CE is determined based on a number of RS resource subgroup(s) indicated by each candidate format in a candidate format group; the candidate format group comprises at least one candidate format in the first candidate format set.

In one embodiment, when an RS resource subgroup other than the first RS resource set is associated with an SpCell, the RS resource subgroup is not indicated by any candidate format.

In one embodiment, when an RS resource subgroup other than the first RS resource set is associated with an SpCell, the RS resource subgroup is not indicated by the format of the target MAC CE.

In one subembodiment of the embodiment, the RS resource subgroup is indicated by a random access preamble.

In one subembodiment of the embodiment, the RS resource subgroup is indicated by preamble resources of random access.

In one embodiment, when an RS resource subgroup other than the first RS resource set is associated with an SpCell, the RS resource subgroup is indicated by the format of the target MAC CE.

In one subembodiment of the embodiment, the target MAC CE is transmitted in the random access procedure.

In one subembodiment of the embodiment, the target MAC CE is transmitted in Msg3 or MsgA.

In one embodiment, when a candidate format indicates whether there exists at least one RS resource subgroup having BFR in an RS resource group to which an RS resource subgroup belongs, the candidate format indicates the RS resource subgroup.

In one embodiment, when a candidate format indicates whether there exists at least one RS resource subgroup having BFR in an RS resource group to which an RS resource subgroup belongs and the RS resource group to which the RS resource sub-group belongs is associated with a secondary cell, the candidate format indicates the RS resource subgroup.

In one embodiment, when a candidate format indicates whether an RS resource group to which an RS resource subgroup belongs has BFR, the candidate format indicates the RS resource subgroup.

In one embodiment, when a candidate format indicates whether an RS resource group to which an RS resource subgroup belongs has BFR and the RS resource group to which the RS resource subgroup belongs is associated with an SCell, the candidate format indicates the RS resource subgroup.

In one embodiment, when a candidate format comprises a Ci field indicating a cell, if there exists the RS resource subgroup associated with the cell in the first RS resource set, the RS resource subgroup associated with the cell is indicated by the candidate format.

In one embodiment, when an RS resource subgroup is uniquely determined by at least one field in a candidate format, a candidate format indicates the RS resource subgroup.

In one embodiment, when an RS resource subgroup corresponds one-to-one with at least one field in a candidate format, and the at least one field is not all associated with another RS resource subgroup other than the RS resource subgroup, a candidate format indicates the RS resource subgroup.

In one embodiment, if an RS resource group comprises two RS resource subgroups, one of the two RS resource subgroups is the first-type RS resource subgroup, and the other RS resource subgroup in the two RS resource subgroups is the second-type RS resource subgroup.

In one subembodiment of the embodiment, whether an RS resource subgroup is the first-type RS resource subgroup or the second-type RS resource subgroup is predefined.

In one subembodiment of the embodiment, the first-type RS resource subgroup is an RS resource subgroup associated with a primary TRP, and the second-type RS resource subgroup is an RS resource subgroup associated with a secondary TRP.

In one subembodiment of the embodiment, the first-type RS resource subgroup is an RS resource subgroup with an index equal to 0 in an RS resource group, and the second-type RS resource subgroup is an RS resource subgroup with an index equal to 1 in an RS resource group; or, the first-type RS resource subgroup is an RS resource subgroup with an index equal to 1 in an RS resource group, and the second-type RS resource subgroup is an RS resource subgroup with an index equal to 0 in an RS resource group.

In one embodiment, the format of the target MAC CE comprises: a number of bitmap(s) comprised in the format of the target MAC CE.

In one embodiment, the format of the target MAC CE comprises: a size of a bitmap immediately following a MAC sub-header in the format of the target MAC CE.

In one embodiment, the format of the target MAC CE comprises: an amount of BFR information in the format of the target MAC CE.

In one embodiment, the format of the target MAC CE comprises: an order of BFR information in the format of the target MAC CE.

In one embodiment, the format of the target MAC CE comprises: information that each bitmap in the format of the target MAC CE is used to indicate.

In one embodiment, the format of the target MAC CE comprises: a format of BFR information in the format of the target MAC CE.

In one embodiment, the format of the target MAC CE comprises: a size of a third bitmap in the format of the target MAC CE; herein, the format of the target MAC CE comprises the second bitmap and the third bitmap.

In one embodiment, the behavior of “determining a format of a target MAC CE according to a number of RS resource subgroup(s) indicated by each candidate format in at least one candidate format in a first candidate format set” comprises: the format of the target MAC CE is determined based on a number of RS resource subgroup(s) in the first RS resource set and a number of RS resource group(s) in the first RS resource set.

In one subembodiment of the embodiment, if a number of RS resource subgroup(s) in the first RS resource set is equal to a number of RS resource group(s) in the first RS resource set, the format of the target MAC CE is a candidate format comprising a bitmap; if a number of RS resource subgroup(s) in the first RS resource set is greater than a number of RS resource group(s) in the first RS resource set, the format of the target MAC CE comprises a candidate format of two bitmaps.

In one subembodiment of the embodiment, if a number of RS resource subgroup(s) in the first RS resource set is equal to a number of RS resource group(s) in the first RS resource set, the format of the target MAC CE is a candidate format comprising two bitmaps; if a number of RS resource subgroup(s) in the first RS resource set is greater than a number of RS resource group(s) in the first RS resource set, the format of the target MAC CE comprises a candidate format of a bitmap.

In one embodiment, the behavior of “determining a format of a target MAC CE according to a number of RS resource subgroup(s) indicated by each of at least one candidate format in a first candidate format set” comprises: the format of the target MAC CE is determined according to a number RS resource subgroup(s) belonging to a first-type RS resource subgroup indicated by each candidate format in the at least one candidate format in the first candidate format set and a number of RS resource subgroup(s) belonging to a second-type RS resource subgroup.

In one subembodiment of the embodiment, a number of RS resource subgroup(s) belonging to a first-type RS resource subgroup in the first RS resource set and a number of RS resource subgroup(s) belonging to a second-type RS resource subgroup in the first RS resource set are used to determine a number of RS resource subgroup(s) indicated by each candidate format in the at least one candidate format in the first candidate format set.

In one subembodiment of the embodiment, the format of the target MAC CE is determined according to a number of RS resource subgroup(s) belonging to a first-type RS resource subgroup in the first RS resource set and a number of RS resource subgroup(s) belonging to a second-type RS resource subgroup in the first RS resource set.

In one subembodiment of the embodiment, if a number of RS resource subgroup(s) belonging to a first-type RS resource subgroup in the first RS resource set is equal to 0 or a number of RS resource subgroup(s) belonging to a second-type RS resource subgroup in the first RS resource set is equal to 0, the format of the target MAC CE is a candidate format comprising a bitmap.

In one subsidiary embodiment of the subembodiment, the bitmap is the first bitmap; the first bitmap is used to indicate the first-type RS resource subgroup, or the first bitmap is used to indicate the second-type RS resource subgroup.

In one subembodiment of the embodiment, if a number of RS resource subgroup(s) belonging to a first-type RS resource subgroup in the first RS resource set and a number of RS resource subgroup(s) belonging to a second-type RS resource subgroup in the first RS resource set are both not equal to 0, the format of the target MAC CE comprises one candidate format in two bitmaps.

In one subsidiary embodiment of the subembodiment, the two bitmaps are the second bitmap and the third bitmap; the second bitmap is used to indicate the first-type RS resource subgroup, and the third bitmap is used to indicate the second-type RS resource subgroup.

In one embodiment, under the condition of not exceeding a size of resources granted by the first uplink grant, a format of a target MAC CE is determined based on a maximum value of a cell identity of a cell associated with an RS resource group to which an RS resource subgroup indicated by each of at least one candidate format in the first candidate format belongs.

In one subembodiment of the embodiment, a format of a target MAC CE is determined based on a maximum value of a cell identity of a cell associated with an RS resource group to which an RS resource subgroup indicated by each candidate format in a candidate format group belongs; the candidate format group comprises at least one candidate format in the first candidate format set.

In one subembodiment of the embodiment, a format of a target MAC CE is determined based on a maximum value of a cell identity of a cell associated with an RS resource group to which an RS resource subgroup in the first RS resource set belongs.

In one subembodiment of the embodiment, a size of a bitmap immediately following a MAC sub-header in the format of the target MAC CE is determined based on a maximum value of a cell identity of a cell associated with an RS resource subgroup to which an RS resource subgroup indicated by each of the at least one candidate format in a first candidate format belongs.

In one subembodiment of the embodiment, if a maximum value of a cell identity of a cell associated with an RS resource group to which an RS resource subgroup in the first RS resource set belongs is greater than 7, the format of the target MAC CE is a candidate format in which a size of a bitmap immediately following a MAC sub-header is equal to 4 bytes; if a maximum value of a cell identity of a cell associated with an RS resource group to which an RS resource subgroup in the first RS resource set belongs is not greater than 7, the format of the target MAC CE is a candidate format in which a size of a bitmap immediately following a MAC sub-header is equal to 1 byte.

In one subsidiary embodiment of the subembodiment, the bitmap immediately following the MAC sub-header is the first bitmap.

In one subsidiary embodiment of the subembodiment, the bitmap immediately following the MAC sub-header is a second bitmap.

In one embodiment, under the condition of not exceeding the size of the resources granted by the first uplink grant, a size of a bitmap immediately following a MAC sub-header in the format of the target MAC CE is determined based on a maximum value of a cell identity of a cell associated with an RS resource subgroup to which an RS resource subgroup indicated by each of the at least one candidate format in a first candidate format belongs; if the size of the bitmap immediately following a MAC sub-header in each of the at least two candidate formats (for clarity of presentation, the at least two candidate formats in the at least one candidate format are referred to as candidate format group #1) in the at least one candidate format in the first candidate format set is equal to the size of the bitmap immediately following a MAC sub-header in the format of the determined target MAC CE, then a number of bitmap(s) comprised in the format of the target MAC CE is determined based on a number of RS resource subgroup(s) indicated by each candidate format in (candidate format group #1); if numbers of RS resource subgroups indicated by at least two candidate formats (for clarity of presentation, the at least two candidate formats in the candidate format group #1 are referred to as candidate format group #2) in (candidate format group #1) are tied, the format of the target MAC CE is a candidate format with a largest amount of BFR information contained in the (Candidate Format Group #2).

In one subembodiment of the embodiment, the “if there exist numbers of RS resource subgroups indicated by at least two candidate formats (candidate format group #2) in (candidate format group #1) being tied” refers to: if there exist numbers of RS resource subgroups indicated by at least two candidate formats (candidate format group #2) in (candidate format group #1) being tied for maximum.

In one subembodiment of the embodiment, the “if there exist numbers of RS resource subgroups indicated by at least two candidate formats (candidate format group #2) in (candidate format group #1) being tied” refers to: if there exist numbers of RS resource subgroups indicated by at least two candidate formats (candidate format group #2) in (candidate format group #1) being tied for minimum.

In one embodiment, the behavior of “determining a format of a target MAC CE according to a number of RS resource subgroup(s) indicated by each of at least one candidate format in a first candidate format set” comprises: under the condition of not exceeding a size of resources granted by the first uplink grant, determining the format of the target MAC CE based on a number of RS resource subgroup(s) indicated by each of the at least one candidate format in the first candidate format set.

In one embodiment, the behavior of “determining a format of a target MAC CE according to a number of RS resource subgroup(s) indicated by each of at least one candidate format in a first candidate format set” comprises: under the condition of not exceeding a size of resources granted by the first uplink grant, the format of the target MAC CE is a candidate format with a largest number of RS resource subgroup(s) indicated by the at least one candidate format in the first candidate format set.

In one embodiment, the behavior of “determining a format of a target MAC CE according to a number of RS resource subgroup(s) indicated by each of at least one candidate format in a first candidate format set” comprises: under the condition of not exceeding a size of resources granted by the first uplink grant, the format of the target MAC CE is a candidate format with a smallest number of RS resource subgroup(s) indicated by at least one candidate format in the first candidate format set.

In one embodiment, the behavior of “determining a format of a target MAC CE according to a number of RS resource subgroup(s) indicated by each of at least one candidate format in a first candidate format set” comprises: under the condition of not exceeding a size of resources granted by the first uplink grant, numbers of RS resource subgroups indicated by the at least two candidate formats in the first candidate format set are tied for largest; the format of the target MAC CE is a candidate format containing a largest amount of BFR information in the at least two candidate formats.

In one embodiment, the behavior of “determining a format of a target MAC CE according to a number of RS resource subgroup(s) indicated by each of at least one candidate format in a first candidate format set” comprises: under the condition of not exceeding a size of resources granted by the first uplink grant, numbers of RS resource subgroups indicated by the at least two candidate formats in the first candidate format set are tied for smallest; the format of the target MAC CE is a candidate format containing a largest amount of BFR information in the at least two candidate formats.

In one embodiment, a number of RS resource subgroup(s) indicated by one candidate format in the at least one candidate format in the first candidate format set is equal to a number of RS resource subgroup(s) in the first RS resource set.

In one embodiment, a number of RS resource subgroup(s) indicated by a candidate format in the at least one candidate format in the first candidate format set is less than a number of RS resource subgroup(s) in the first RS resource set.

In one embodiment, a number of RS resource subgroup(s) indicated by one candidate format in the at least one candidate format in the first candidate format set is greater than a number of RS resource subgroup(s) in the first RS resource set.

In one embodiment, the phrase of a number of RS resource subgroup(s) indicated by each of at least one candidate format in a first candidate format set comprises: a number of RS resource subgroup(s) in the first RS resource set.

In one embodiment, the phrase of a number of RS resource subgroup(s) indicated by each of at least one candidate format in a first candidate format set comprises: a number of RS resource subgroup(s) in the first RS resource set that can be indicated by each candidate format in the at least one candidate format in the first candidate format set.

In one embodiment, the phrase of a number of RS resource subgroup(s) indicated by each of at least one candidate format in a first candidate format set comprises: a number of RS resource subgroup(s) in the first RS resource set that can be indicated by one bitmap or two bitmaps in each candidate format in the at least one candidate format in the first candidate format set.

In one embodiment, the phrase of a number of RS resource subgroup(s) indicated by each of at least one candidate format in a first candidate format set comprises: a number of RS resource subgroup(s) indicated by one candidate format in the first candidate format set.

In one embodiment, the phrase of a number of RS resource subgroup(s) indicated by each of at least one candidate format in a first candidate format set comprises: a number of RS resource subgroup(s) indicated by each candidate format in at least two candidate formats in a first candidate format set; a number of candidate format(s) in the at least two candidate formats is less than a number of candidate format(s) in the first candidate format set.

In one embodiment, the phrase of a number of RS resource subgroup(s) indicated by each of at least one candidate format in a first candidate format set comprises: a number of RS resource subgroup(s) indicated by each candidate format in all candidate formats in the first candidate format set.

In one embodiment, one candidate format in the first candidate format set comprises candidate format A1; the candidate format A1 comprises a first bitmap with a size equal to 1 byte, a field in the first bitmap is used to indicate whether there exists and only exists an RS resource subgroup having BFR in an RS resource group determined by the field; if a field in the bitmap indicates that there exists and only exists an RS resource subgroup having BFR in an RS resource group determined by the field, the candidate format A1 comprises BFR information associated with the RS resource subgroup.

In one subembodiment of the embodiment, the candidate format A1 is a complete MAC CE format.

In one subembodiment of the above embodiment, the candidate format A1 comprises BFR information for all RS resource subgroups with a cell identity (ID) of an associated cell in the first RS resource set being less than 8.

In one subembodiment of the above embodiment, a number of RS resource subgroup(s) in the first RS resource set indicated by the candidate format A1 is equal to Q1, Q1 is a non-negative integer, and Q1 is not greater than 8; Q1 refers to a number of RS resource group(s) with a cell identity (ID) of an associated cell in the first RS resource set being less than 8.

In one subembodiment of the above embodiment, each bit in the first bitmap corresponds to an RS resource subgroup.

In one subembodiment of the above embodiment, each bit in the first bitmap corresponds to an RS resource group.

In one embodiment, one candidate format in the first candidate format set comprises candidate format A2; the candidate format A2 comprises a first bitmap with a size equal to 4 byte, a field in the first bitmap is used to indicate whether there exists and only exists an RS resource subgroup having BFR in an RS resource group determined by the field; if a field in the bitmap indicates that there exists and only exists an RS resource subgroup having BFR in an RS resource group determined by the field, the candidate format A2 comprises BFR information associated with the RS resource subgroup.

In one subembodiment of the embodiment, the candidate format A2 is a complete MAC CE format.

In one subembodiment of the embodiment, the candidate format A2 comprises BFR information of all RS resource subgroups in the first RS resource set.

In one subembodiment of the embodiment, a number of RS resource subgroup(s) in the first RS resource set indicated by the candidate format A2 is equal to Q2, Q2 being a positive integer, Q2 being not greater than 32; the Q2 is a number of RS resource group(s) in the first RS resource set.

In one subembodiment of the above embodiment, the first RS resource set comprises a cell identity of a cell associated with at least one RS resource subgroup being greater than 8.

In one subembodiment of the above embodiment, each bit in the first bitmap corresponds to an RS resource subgroup.

In one subembodiment of the above embodiment, each bit in the first bitmap corresponds to an RS resource group.

In one embodiment, one candidate format in the first candidate format set comprises candidate format A3; the candidate format A3 comprises a first bitmap with a size equal to 1 byte, a field in the first bitmap is used to indicate whether there exists and only exists an RS resource subgroup having BFR in an RS resource group determined by the field; if a field in the first bitmap indicates that there exists and only exists an RS resource subgroup having BFR in an RS resource group determined by the field, whether the candidate format A3 comprises BFR information associated with the RS resource subgroup is related to a size of resources granted by the first uplink grant.

In one subembodiment of the embodiment, the candidate format A3 is a truncated MAC CE format.

In one subembodiment of the embodiment, the candidate format A3 does not comprise BFR information of at least one RS resource subgroup in the first RS resource set.

In one subembodiment of the embodiment, if the size of the resources granted by the first uplink grant cannot contain all BFR information, the candidate format A3 does not comprise BFR information for at least one RS resource subgroup in the first RS resource set.

In one subembodiment of the above embodiment, a number of RS resource subgroup(s) in the first RS resource set indicated by the candidate format A3 is equal to Q3, Q3 being a non-negative integer, Q3 being not greater than 8; Q3 refers to a number of RS resource group(s) with a cell identity (ID) of an associated cell in first RS resource set being less than 8.

In one subembodiment of the above embodiment, each bit in the first bitmap corresponds to an RS resource subgroup.

In one subembodiment of the above embodiment, each bit in the first bitmap corresponds to an RS resource group.

In one embodiment, one candidate format in the first candidate format set comprises candidate format A4; the candidate format A4 comprises a first bitmap with a size equal to 4 byte, a field in the first bitmap is used to indicate whether there exists and only exists an RS resource subgroup having BFR in an RS resource group determined by the field; if a field in the first bitmap indicates that there exists and only exists an RS resource subgroup having BFR in an RS resource group determined by the field, whether the candidate format A4 comprises BFR information associated with the RS resource subgroup is related to a size of resources granted by the first uplink grant.

In one subembodiment of the embodiment, the candidate format A4 is a truncated MAC CE format.

In one subembodiment of the embodiment, the candidate format A4 does not comprise BFR information of at least one RS resource subgroup in the first RS resource set.

In one subembodiment of the embodiment, if the size of the resources granted by the first uplink grant cannot contain all BFR information, the candidate format A4 does not comprise BFR information for at least one RS resource subgroup in the first RS resource set.

In one subembodiment of the embodiment, a number of RS resource subgroup(s) in the first RS resource set indicated by the candidate format A4 is equal to Q4, Q4 being a positive integer, Q4 not being greater than 32; the Q4 is a number of RS resource group(s) in the first RS resource set.

In one subembodiment of the above embodiment, the first RS resource set comprises a cell identity of a cell associated with at least one RS resource subgroup being greater than 8.

In one subembodiment of the above embodiment, each bit in the first bitmap corresponds to an RS resource subgroup.

In one subembodiment of the above embodiment, each bit in the first bitmap corresponds to an RS resource group.

In one embodiment, one candidate format in the first candidate format set comprises candidate format A5; the candidate format A5 comprises a second bitmap with a size equal to 1 byte and a third bitmap with a size equal to 1 byte, a field in the second bitmap is used to indicate whether an RS resource subgroup determined by the field has BFR, and a field in the third bitmap is used to indicate whether another RS resource subgroup determined by the field has BFR, and both the RS resource subgroup and the another RS resource subgroup belong to a same RS resource group; if a field in the second bitmap or a third bitmap indicates that an RS resource subgroup determined by the field has BFR, the candidate format A5 comprises BFR information associated with the RS resource subgroup.

In one subembodiment of the embodiment, the candidate format A5 is a complete MAC CE format.

In one subembodiment of the above embodiment, the candidate format A5 comprises BFR information for all RS resource subgroups with a cell identity (ID) of an associated cell in the first RS resource set less than 8.

In one subembodiment of the above embodiment, a number of RS resource subgroup(s) in the first RS resource set indicated by the candidate format A5 is equal to Q5, Q5 being a non-negative integer, Q5 being not greater than 16; Q5 refers to a number of RS resource subgroup(s) with cell ID(s) of associated cell(s) in the first RS resource set less than 8.

In one subembodiment of the above embodiment, Q5 is not greater than 15.

In one subembodiment of the above embodiment, each bit in the first bitmap corresponds to an RS resource subgroup.

In one embodiment, one candidate format in the first candidate format set comprises candidate format A6; the candidate format A6 comprises a second bitmap with a size equal to 4 byte and a third bitmap with a size equal to 4 byte, a field in the second bitmap is used to indicate whether an RS resource subgroup determined by the field has BFR, and a field in the third bitmap is used to indicate whether another RS resource subgroup determined by the field has BFR, and both the RS resource subgroup and the another RS resource subgroup belong to a same RS resource group; if a field in the second bitmap or a third bitmap indicates that an RS resource subgroup determined by the field has BFR, the candidate format A5 comprises BFR information associated with the RS resource subgroup.

In one subembodiment of the embodiment, the candidate format A6 is a complete MAC CE format.

In one subembodiment of the embodiment, the candidate format A6 comprises BFR information of all RS resource subgroups in the first RS resource set.

In one subembodiment of the embodiment, a number of RS resource subgroup(s) in the first RS resource set indicated by the candidate format A6 is equal to Q6, Q6 being a positive integer, Q6 not being greater than 64; the Q6 is a number of RS resource subgroup(s) in the first RS resource set.

In one subembodiment of the above embodiment, Q6 is not greater than 63.

In one subembodiment of the above embodiment, the first RS resource set comprises a cell ID of a cell associated with at least one RS resource subgroup being greater than 8.

In one subembodiment of the above embodiment, each bit in the first bitmap corresponds to an RS resource subgroup.

In one embodiment, one candidate format in the first candidate format set comprises candidate format A7; the candidate format A7 comprises a second bitmap with a size equal to 1 byte and a third bitmap with a size equal to 1 byte, a field in the second bitmap is used to indicate whether an RS resource subgroup determined by the field has BFR, and a field in the third bitmap is used to indicate whether another RS resource subgroup determined by the field has BFR, and both the RS resource subgroup and the another RS resource subgroup belong to a same RS resource group; if a field in the second bitmap or a third bitmap indicates that an RS resource subgroup determined by the field has BFR, whether the candidate format A7 comprises BFR information associated with the RS resource subgroup is related to a size of resources granted by the first uplink grant.

In one subembodiment of the embodiment, the candidate format A7 is a truncated MAC CE format.

In one subembodiment of the above embodiment, a number of RS resource subgroup(s) in the first RS resource set indicated by the candidate format A7 is equal to Q7, Q7 being a non-negative integer, Q7 being not greater than 16; Q7 refers to a number of RS resource subgroup(s) with cell ID(s) of associated cell(s) in the first RS resource set being less than 8.

In one subembodiment of the above embodiment, Q7 is not greater than 15.

In one subembodiment of the above embodiment, each bit in the first bitmap corresponds to an RS resource subgroup.

In one embodiment, one candidate format in the first candidate format set comprises candidate format A8; the candidate format A8 comprises a second bitmap with a size equal to 4 byte and a third bitmap with a size equal to 4 byte, a field in the second bitmap is used to indicate whether an RS resource subgroup determined by the field has BFR, and a field in the third bitmap is used to indicate whether another RS resource subgroup determined by the field has BFR, and both the RS resource subgroup and the another RS resource subgroup belong to a same RS resource group; if a field in the second bitmap or a third bitmap indicates that an RS resource subgroup determined by the field has BFR, whether the candidate format A8 comprises BFR information associated with the RS resource subgroup is related to a size of resources granted by the first uplink grant.

In one subembodiment of the embodiment, the candidate format A8 is a truncated MAC CE format.

In one subembodiment of the embodiment, a number of RS resource subgroup(s) in the first RS resource set indicated by the candidate format A8 is equal to Q8, Q8 being a positive integer, Q8 not being greater than 64; the Q8 is a number of RS resource subgroup(s) in the first RS resource set.

In one subembodiment of the above embodiment, Q8 is not greater than 63.

In one subembodiment of the above embodiment, the first RS resource set comprises a cell identity of a cell associated with at least one RS resource subgroup being greater than 8.

In one subembodiment of the above embodiment, each bit in the first bitmap corresponds to an RS resource subgroup.

In one embodiment, one candidate format in the first candidate format set comprises candidate format A9; the candidate format A9 comprises a second bitmap with a size equal to 1 byte and a third bitmap with a size equal to 1 byte, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, the candidate format A9 comprises BFR information associated with each of the at least one RS resource subgroup.

In one subembodiment of the embodiment, the candidate format A9 is a complete MAC CE format.

In one subembodiment of the above embodiment, the candidate format A9 comprises BFR information for all RS resource subgroups with cell IDs of associated cells in the first RS resource set less than 8.

In one subembodiment of the above embodiment, a number of RS resource subgroup(s) in the first RS resource set indicated by the candidate format A9 is equal to Q9, Q9 being a non-negative integer, Q9 being not greater than 16; Q9 refers to a number of RS resource subgroup(s) with cell ID(s) of associated cell(s) in the first RS resource set being less than 8.

In one subembodiment of the above embodiment, Q9 is not greater than 15.

In one subembodiment of the above embodiment, each bit in the first bitmap corresponds to an RS resource subgroup.

In one embodiment, one candidate format in the first candidate format set comprises candidate format A10; the candidate format A10 comprises a second bitmap with a size equal to 4 bytes and a third bitmap with a variable size, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, the candidate format A10 comprises BFR information associated with each of the at least one RS resource subgroup.

In one subembodiment of the embodiment, the candidate format A10 is a complete MAC CE format.

In one subembodiment of the above embodiment, the candidate format A10 comprises BFR information for all RS resource subgroups with cell IDs of associated cells in the first RS resource set less than 8.

In one subembodiment of the embodiment, a number of RS resource subgroup(s) in the first RS resource set indicated by the candidate format A10 is equal to Q10, Q10 being a positive integer, Q10 not being greater than 64; the Q2 is a number of RS resource subgroup(s) in the first RS resource set.

In one subembodiment of the above embodiment, Q10 is not greater than 63.

In one subembodiment of the above embodiment, the first RS resource set comprises a cell identity of a cell associated with at least one RS resource subgroup being greater than 8.

In one subembodiment of the above embodiment, each bit in the first bitmap corresponds to an RS resource subgroup.

In one subembodiment of the above embodiment, a size of the third bitmap is related to the second bitmap.

In one embodiment, one candidate format in the first candidate format set comprises candidate format A11; the candidate format A11 comprises a second bitmap with a size equal to 1 byte and a third bitmap with a size equal to 1 byte, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, whether the candidate format A11 comprises BFR information associated with each of the at least one RS resource subgroup is related to a size of resources granted by the first uplink grant.

In one subembodiment of the embodiment, the candidate format A11 is a truncated MAC CE format.

In one subembodiment of the above embodiment, a number of RS resource subgroup(s) in the first RS resource set indicated by the candidate format A11 is equal to Q11, Q11 being a non-negative integer, Q11 being not greater than 16; Q11 refers to a number of RS resource subgroup(s) with cell ID(s) of associated cell(s) in the first RS resource set being less than 8.

In one subembodiment of the above embodiment, Q11 is not greater than 16.

In one subembodiment of the above embodiment, each bit in the first bitmap corresponds to an RS resource subgroup.

In one embodiment, one candidate format in the first candidate format set comprises candidate format A12; the candidate format A12 comprises a second bitmap with a size equal to 4 bytes and a third bitmap with a variable size, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in an RS resource group, whether the candidate format A12 comprises BFR information associated with BFR information of each of the at least one RS resource subgroup is related to a size of resources granted by the first uplink grant.

In one subembodiment of the embodiment, the candidate format A12 is a truncated MAC CE format.

In one subembodiment of the embodiment, a number of RS resource subgroup(s) in the first RS resource set indicated by the candidate format A12 is equal to Q12, Q12 being a positive integer, Q12 not being greater than 64; the Q12 is a number of RS resource subgroup(s) in the first RS resource set.

In one subembodiment of the above embodiment, Q12 is not greater than 63.

In one subembodiment of the above embodiment, the first RS resource set comprises a cell identity of a cell associated with at least one RS resource subgroup being greater than 8.

In one subembodiment of the above embodiment, each bit in the first bitmap corresponds to an RS resource subgroup.

In one subembodiment of the above embodiment, a size of the third bitmap is related to the second bitmap.

In one embodiment, a candidate format in the first candidate format set comprises candidate format

B1, the candidate format B1 being a BFR MAC CE format in which an LCID field in a corresponding MAC sub-header in 3GPP TS38.321 is set to 50.

In one embodiment, one candidate format in the at least one candidate format in the first candidate format set comprises candidate format B2, and the candidate format B2 is a BFR MAC CE format with an eLCID field set to 250 in a corresponding MAC sub-header of 3GPP TS38.321.

In one embodiment, a candidate format in the first candidate format set comprises candidate format B3, and the candidate format B3 is a BFR MAC CE format with an LCID field set to 51 in a corresponding MAC sub-header in 3GPP TS38.321.

In one embodiment, one candidate format in the first candidate format set comprises candidate format B4, and the candidate format B4 is a BFR MAC CE format with an eLCID field set to 251 in a corresponding MAC sub-header in 3GPP TS38.321.

In one embodiment, a candidate format in the first candidate format set comprises a BFR MAC CE format in 3GPP TS38.321 current release (R16).

In one embodiment, a candidate format in the first candidate format set comprises a BFR MAC CE format in 3GPP TS38.321 future release (R17).

In one embodiment, the first candidate format set comprises at least one of the candidate format A1, . . . , or the candidate format A12.

In one embodiment, the first candidate format set comprises at least two of the candidate format A1, . . . , and the candidate format A12.

In one embodiment, the first candidate format set comprises at least one of the candidate format B1, . . . , or the candidate format B4.

In one embodiment, the first candidate format set comprises at least two of the candidate format B1, . . . , and the candidate format B4.

In one embodiment, the phrase that “an RS resource subgroup indicated by any of the at least one candidate format in the first candidate format set is an RS resource subgroup in the first RS resource set” comprises: an RS resource subgroup indicated by any of the at least one candidate format in the first candidate format set belongs to the first RS resource set.

In one embodiment, the phrase that “an RS resource subgroup indicated by any of the at least one candidate format in the first candidate format set is an RS resource subgroup in the first RS resource set” comprises: all RS resource subgroups indicated by any of the at least one candidate format in the first candidate format set belong to a subset of the first RS resource set.

In one embodiment, a name of the target MAC CE comprises a BFR MAC CE.

In one embodiment, a name of the target MAC CE comprises Truncated and a BFR MAC CE.

In one embodiment, a name of the target MAC CE comprises BFR MAC CE, or Truncated, or at least one of TRP or RS or Set or per.

In one embodiment, the target MAC CE is transmitted on a UL-SCH (Uplink Shared Channel).

In one embodiment, the target MAC CE belongs to a MAC sub-PDU.

In one embodiment, the target MAC CE belongs to a MAC PDU.

In one embodiment, a MAC PDU comprising the target MAC CE only comprises the target MAC CE and a sub-header of the target MAC CE.

In one embodiment, a MAC PDU comprising the target MAC CE comprises the target MAC CE and a C-RNTI (Cell Radio Network Temporary Identifier) MAC CE, as well as a sub-header of the target MAC CE and a sub-header of the C-RNTI MAC CE.

In one embodiment, a MAC PDU comprising the target MAC CE comprises the target MAC CE, and a MAC PDU comprising the target MAC CE comprises at least one of a MAC SDU or a MAC CE or a MAC sub-header.

In one subembodiment of the embodiment, the MAC CE is not used to indicate BFR.

In one subembodiment of the embodiment, an LCID (Logical Channel Identity) in the MAC CE is not equal to 50 or 51.

In one subembodiment of the embodiment, an eLCID (Extended Logical Channel ID) in the MAC CE is not equal to 50 or 51.

In one embodiment, the target MAC CE comprises 0 BFR information.

In one embodiment, the target MAC CE comprises at least one BFR information.

In one embodiment, an amount of BFR information comprised in the target MAC CE is related to the first uplink grant.

In one embodiment, an amount of BFR information comprised in the target MAC CE is related to the LCP (Logical Channel Prioritization) process.

In one embodiment, an amount of BFR information comprised in the target MAC CE is related to whether there exists a MAC CE or MAC SDU (Service Data Unit) with a logical channel prioritization order higher than the target MAC CE.

In one embodiment, BFR information is associated with an RS resource subgroup.

In one embodiment, if an RS resource group comprises an RS resource subgroup without BFR, the RS resource group comprises one BFR information; if an RS resource group does not comprise an RS resource subgroup without BFR, and a number of RS resource subgroup(s) in the RS resource group is equal to 1, the RS resource group comprises one BFR information; if an RS resource group does not comprise an RS resource subgroup without BFR, and a number of RS resource subgroup(s) in the RS resource group is equal to 2, the RS resource group comprises two BFR information.

In one embodiment, the behavior of “transmitting the target MAC CE according to an instruction of the first uplink grant” comprises: generating the target MAC CE based on an indication granted by the first uplink grant.

In one embodiment, the behavior of “transmitting the target MAC CE according to an instruction of the first uplink grant” comprises: transmitting the target MAC CE on resources indicated by the first uplink grant.

In one embodiment, the behavior of “transmitting the target MAC CE according to an instruction of the first uplink grant” comprises: transmitting the target MAC CE based on a size of resources granted by the first uplink grant.

In one embodiment, the behavior of “transmitting the target MAC CE according to an instruction of the first uplink grant” comprises: transmitting the target MAC CE according to a type of the first uplink grant.

In one embodiment, the behavior of “transmitting the target MAC CE according to an instruction of the first uplink grant” comprises: instructing the physical layer to generate a transmission based on the first uplink grant.

In one embodiment, the behavior of “transmitting the target MAC CE according to an instruction of the first uplink grant” comprises: transmitting a MAC PDU based on an instruction of the first uplink grant, and the MAC PDU comprises the target MAC CE.

In one embodiment, the phrase that “the format of the target MAC CE is one format in the first candidate format set” comprises: the format of the target MAC CE is a format used to indicate a MAC CE of BFR.

In one embodiment, the phrase that “the format of the target MAC CE is one format in the first candidate format set” comprises: the target MAC CE is determined in the first candidate format set.

In one embodiment, the phrase that “the format of the target MAC CE is one format in the first candidate format set” comprises: the target MAC CE is selected in the first candidate format set.

In one embodiment, the phrase that “each candidate format in the first candidate format set is a format used to indicate a MAC CE of BFR” comprises: the each candidate format in the first candidate format set is a MAC CE format, and the MAC CE format comprises at least one field used to indicate BFR.

In one embodiment, the phrase that “each candidate format in the first candidate format set is a format used to indicate a MAC CE of BFR” comprises: the each candidate format in the first candidate format set is a MAC CE format, and at least one field in the MAC CE format is used to indicate BFR-related information.

In one embodiment, the phrase that “each candidate format in the first candidate format set is a format used to indicate a MAC CE of BFR” comprises: the each candidate format in the first candidate format set is a MAC CE format, and the MAC CE format can be used to indicate an RS resource subgroup having BFR, and the MAC CE format can be used to indicate whether there exists a candidate RS resource for an RS resource subgroup having BFR, and the MAC CE format can be used to indicate the candidate RS resource.

In one embodiment, each candidate format in the first candidate format set is a BFR MAC CE format.

In one embodiment, each candidate format in the first candidate format set is used for BFR.

In one embodiment, each candidate format in the first candidate format set is used to indicate at least a former of at least one RS resource subgroup having BFR, or candidate RS resource information respectively corresponding to at least one RS resource subgroup in the at least one RS resource subgroup having BFR.

In one embodiment, the first candidate format set comprises at least two candidate formats.

In one embodiment, the first candidate format set comprises at least three candidate formats.

In one embodiment, the first candidate format and the second candidate format corresponding to different LCID code points/indexes is used to determine that the first candidate format and the second candidate format are different.

In one embodiment, an LCID field in a MAC sub-header corresponding to the first candidate format and an LCID field in a MAC sub-header corresponding to the second candidate format are set to different values to determine that the first candidate format and the second candidate format are different.

In one embodiment, an LCID field in a MAC sub-header is set to different values to determine that the first candidate format and the second candidate format are different.

In one embodiment, the first candidate format and the second candidate format correspond to a same LCID code point/index, and a first field in a MAC sub-header is used to indicate the first candidate format and second candidate format.

In one embodiment, an LCID field in a MAC sub-header corresponding to the first candidate format and an LCID field in a MAC sub-header corresponding to the second candidate format are set to a same value, a first field in a MAC sub-header corresponding to the first candidate format being set as a first value is used to indicate the first candidate format, and a first field in a MAC sub-header corresponding to the second candidate format being set as a second value is used to indicate the second candidate format.

In one embodiment, the above first field in the MAC sub-header comprises a most significant bit in the MAC sub-header.

In one embodiment, the above first field in the MAC sub-header occupies a first bit in the MAC sub-header.

In one embodiment, the above first field in the MAC sub-header occupies a field located before an F field in the MAC sub-header.

In one embodiment, the above first field in the MAC sub-header comprises 1 bit.

In one embodiment, the above first value being equal to 1 indicates the first candidate format, and the first value being equal to 0 indicates the second candidate format.

In one embodiment, the above first value being equal to 0 indicates the first candidate format, and the first value being equal to 1 indicates the second candidate format.

In one embodiment, the phrase that “the first candidate format is different from the second candidate format” comprises: a size of the first candidate format and a size of the second candidate format are different.

In one embodiment, the phrase that “the first candidate format is different from the second candidate format” comprises: a maximum amount of BFR information that can be contained in the first candidate format and the second candidate format is different.

In one embodiment, the phrase that “the first candidate format is different from the second candidate format” comprises: numbers of bitmaps comprised in the first candidate format and the second candidate format are different.

In one embodiment, the phrase that “the first candidate format is different from the second candidate format” comprises: sizes of bitmaps comprised in the first candidate format and the second candidate format are different.

In one embodiment, the phrase that “the first candidate format is different from the second candidate format” comprises: at least one bit in the first candidate format and the second candidate format is used to indicate different information.

In one embodiment, the first candidate format is a BFR MAC CE.

In one embodiment, the first candidate format is a Truncated BFR MAC CE.

In one embodiment, a size of the first candidate format is variable.

In one embodiment, the second MAC CE is a BFR MAC CE.

In one embodiment, the second candidate format is a Truncated BFR MAC CE.

In one embodiment, a size of the second candidate format is variable.

In one embodiment, the phrase of “not exceeding a size of resources granted by the first uplink grant” comprises: being less than or equal to the size of the resources granted by the first uplink grant.

In one embodiment, the phrase of “not exceeding a size of resources granted by the first uplink grant” comprises: being not greater than the size of the resources granted by the first uplink grant.

In one embodiment, the first candidate format is one of the candidate format B1, . . . , and the candidate format B4, and the second candidate format is one of the candidate format A1, .. . , and the candidate format A12.

In one embodiment, the first candidate format is one of the candidate format B1, . . . , and the candidate format B4, and the second candidate format is one of the candidate format B1, ..., and the candidate format B4.

In one embodiment, the first candidate format is one of the candidate format A1, . . . , and the candidate format A12, and the second candidate format is one of the candidate format A1, . . . , and the candidate format A12.

In one embodiment, an identity of the cell comprises an identity of a serving cell.

In one embodiment, an identity of the cell comprises an identity of an SCell.

In one embodiment, an identity of the cell is indicated by ServCellIndex.

In one embodiment, an identity of the cell is indicated by SCellIndex.

In one embodiment, an RS resource subgroup having BFR refers to: at least the first-type counter associated with the RS resource subgroup reaches the first-type value.

In one embodiment, an RS resource subgroup having BFR refers to: as a response to the first-type counter associated with the RS resource subgroup reaching the first-type value, BFR associated with the RS resource subgroup is triggered.

In one embodiment, an RS resource subgroup having BFR refers to: beam failure for an RS resource subgroup is detected, and an assessment for a candidate beam associated with the RS resource subgroup is completed.

In one embodiment, an RS resource subgroup having BFR refers to: beam failure at least for the RS resource subgroup is detected.

In one embodiment, an RS resource subgroup having BFR refers to: at least beam failure for the RS resource subgroup is detected, and an assessment for candidate RS resources in the first-type candidate RS resource group associated with the RS resource subgroup is completed.

In one embodiment, an assessment for candidate RS resources in the first-type candidate RS resource group associated with the RS resource subgroup is performed according to requirements of at least R17 and its evolved 3GPP TS38.133.

In one embodiment, an assessment for candidate RS resources in a first-type candidate RS resource group associated with the RS resource subgroup is performed through an SS-RSRP measurement.

In one embodiment, an assessment for candidate RS resources in a first-type candidate RS resource group associated with the RS resource subgroup is performed through a CSI-RSRP measurement.

In one embodiment, if an RS resource group only comprises one RS resource subgroup, the RS resource group having BFR refers to the RS resource subgroup having BFR.

In one embodiment, each RS resource subgroup is associated with a first-type candidate RS resource group, and the first-type candidate RS resource group comprises at least one candidate RS resource.

In one embodiment, the candidate RS resource is an SSB.

In one embodiment, the candidate RS resource is a CSI-RS.

In one embodiment, for each RS resource subgroup, a first-type candidate RS resource group is configured.

In one embodiment, an RS resource subgroup respectively corresponds to a first-type candidate RS resource group.

In one embodiment, an RS resource subgroup and a first-type candidate RS resource group associated with the RS resource subgroup are configured in a same IE.

In one embodiment, an RS resource subgroup and a first-type candidate RS resource group associated with the RS resource subgroup have a same ID.

In one embodiment, an RS resource subgroup and a first-type candidate RS resource group associated with the RS resource subgroup belong to a same cell.

In one embodiment, an RS resource subgroup and a first-type candidate RS resource group associated with the RS resource subgroup belong to a same TRP in a same cell.

In one embodiment, the first-type candidate RS resource group is configured through an RRC message.

In one embodiment, the above RRC message comprises the first signaling.

In one embodiment, the above RRC message comprises an RRC message other than the first signaling.

In one embodiment, one RS resource in the first candidate RS resource set is configured through a field of an RRC message, and a name of the field comprises CandidateBeamRS.

In one embodiment, an RS resource in the first-type candidate RS resource group comprises an SSB indexed by an SSB-Index configured by CandidateBeamRS.

In one embodiment, an RS resource in the first-type candidate RS resource group comprises a CSI-RS indexed by a NZP-CSI-RS-ResourceId configured by CandidateBeamRS.

In one embodiment, the first candidate RS resource set is configured through a field of an RRC message, and a name of the field comprises candidateBeamRSSCellList.

In one embodiment, the first candidate RS resource set is configured through an IE of an RRC message, and a name of the IE comprises BeamFailureRecoverySCellConfiguration.

In one embodiment, the target MAC CE indicates at least one RS resource subgroup having BFR.

In one embodiment, the target MAC CE indicates an RS resource group to which at least one RS resource subgroup having BFR belongs.

In one subembodiment of the above embodiment, indicated RS resource subgroups comprise all RS resource subgroups in indicated RS resource groups.

In one subembodiment of the above embodiment, indicated RS resource subgroups comprise one RS resource subgroup in indicated RS resource groups.

In one embodiment, the behavior of determining a format of a target MAC CE comprises: determining the format of the target MAC CE from the at least one candidate format in the first candidate format set.

In one embodiment, the behavior of determining a format of a target MAC CE comprises: determining the format of the target MAC CE from the first candidate format set.

In one embodiment, the behavior of determining a format of a target MAC CE comprises: determining the format of the target MAC CE from the first candidate format and the second candidate format.

In one embodiment, there at least exists one MAC CE format used to indicate BFR in the first candidate format set exceeding the size of the resources granted by the first uplink grant.

In one subembodiment of the above embodiment, the size of the resources granted by the first uplink grant cannot indicate BFR information of all RS resource subgroups with BFR in the first RS resource set.

In one embodiment, an RS resource group in the first RS resource set is configured for an active BWP in a cell.

In one embodiment, an RS resource group in the first RS resource set is configured for a BWP in a cell.

### Embodiment 2

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 5GS/EPS 200 may be interconnected with other access networks.

For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e. g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB), or a gNB, or an eNB, or an ng-eNB, or an en-gNB, or a UE, or a relay, or a gateway, or at least one TRP.

In one embodiment, the node 203 comprises at least one TRP.

In one embodiment, the node 203 is a logical node.

In one embodiment, different structures in the node 203 are located in a same entity.

In one embodiment, different structures in the node 203 are located in different entities.

In one embodiment, the UE supports Terrestrial Network (NTN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE supports NR.

In one embodiment, the UE supports UTRA.

In one embodiment, the UE supports EUTRA.

In one embodiment, the UE comprises a device supporting transmission with low-latency and high-reliability.

In one embodiment, the UE comprises aircraft, vehicle terminal, ship, IoT terminal, industrial IoT terminal, testing equipment, or signaling tester.

In one embodiment, the base station supports transmission over non-terrestrial networks.

In one embodiment, the base station supports transmission over networks with large latency differences.

In one embodiment, the base station supports transmission over terrestrial networks.

In one embodiment, the base station comprises a base station supporting large latency differences.

In one embodiment, the base station equipment comprises Marco Cellular base station, Micro Cell base station, Pico Cell base station, or Femtocell.

In one embodiment, the base station comprises flight platform equipment, or satellite equipment, or TRP (Transmitter Receiver Point), or CU (Centralized Unit), or DU (Distributed Unit), or testing equipment, or signaling testers, or IAB (Integrated Access and Backhaul)-node, or IAB-donor, or IAB-donor-CU, or IAB-donor-DU, or IAB-DU, or IAB-MT.

In one embodiment, the relay comprises relay, L3 relay, L2 relay, router, or switch.

### Embodiment 3

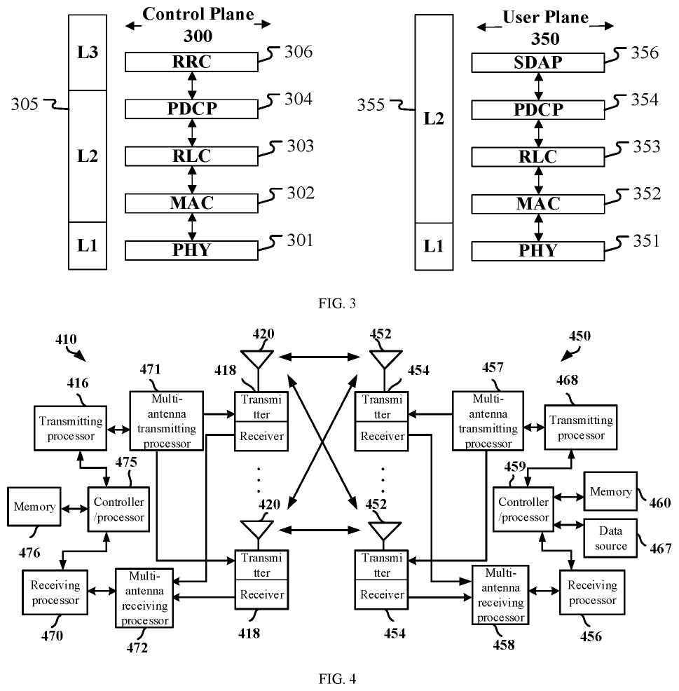

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the target MAC CE in the present application is generated by the MAC 302 or the MAC 352.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452.

Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: receives a first signaling, the first signaling indicates a first RS resource set, the first RS resource set comprises at least one RS resource group, each RS resource group in the at least one RS resource group is associated with a cell, each RS resource group in the at least one RS resource group comprises at least one RS resource subgroup, each RS resource subgroup comprises at least one RS resource; for each RS resource subgroup in the first RS resource set, whenever radio link quality assessed based on the each RS resource subgroup is worse than a first-type threshold, increases a first-type counter corresponding to the each RS resource subgroup by 1; determines whether to trigger a BFR based on whether the first-type counter corresponding to the each RS resource subgroup reaches a first-type value; receives a second signaling, the second signaling indicates a first uplink grant; determines a format of the target MAC CE based on a number of RS resource subgroup(s) indicated by each of at least one candidate format in a first candidate format set, an RS resource subgroup indicated by any of the at least one candidate format in the first candidate format set is an RS resource subgroup in the first RS resource set; transmits the target MAC CE according to an instruction of the first uplink grant; herein, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource; for each RS resource subgroup in the first RS resource set, whenever radio link quality assessed based on the each RS resource subgroup is worse than a first-type threshold, increasing a first-type counter corresponding to the each RS resource subgroup by 1; determining whether to trigger a BFR based on whether the first-type counter corresponding to the each RS resource subgroup reaches a first-type value; receiving a second signaling, the second signaling indicating a first uplink grant; determining a format of a target MAC CE based on a number of RS resource subgroup(s) indicated by each of at least one candidate format in a first candidate format set, an RS resource subgroup indicated by any of the at least one candidate format in the first candidate format set being an RS resource subgroup in the first RS resource set; transmitting the target MAC CE according to an instruction of the first uplink grant; herein, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling indicates a first RS resource set, the first RS resource set comprises at least one RS resource group, each RS resource group in the at least one RS resource group is associated with a cell, each RS resource group in the at least one RS resource group comprises at least one RS resource subgroup, each RS resource subgroup comprises at least one RS resource; transmits a second signaling, the second signaling indicates a first uplink grant; receives a target MAC CE; herein, for each RS resource subgroup in the first RS resource set, whenever radio link quality assessed based on the each RS resource subgroup is worse than a first-type threshold, a first-type counter corresponding to the each RS resource subgroup is increased by 1; whether to trigger a BFR is determined based on whether the first-type counter corresponding to the each RS resource subgroup reaches a first-type value; the target MAC CE is transmitted according to the instruction of the first uplink grant; a format of the target MAC CE is determined based on a number of RS resource subgroup(s) indicated by each of at least one candidate format in a first candidate format set, an RS resource subgroup indicated by any of the at least one candidate format in the first candidate format set is an RS resource subgroup in the first RS resource set; the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the second communication device 410 comprises a memory that stores a computer readable instruction program. The computer readable instruction program generates an action when executed by at least one processor. The action includes: transmitting a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource; transmitting a second signaling, the second signaling indicating a first uplink grant; receiving a target MAC CE; herein, for each RS resource subgroup in the first RS resource set, whenever radio link quality assessed based on the each RS resource subgroup is worse than a first-type threshold, a first-type counter corresponding to the each RS resource subgroup is increased by 1; whether to trigger a BFR is determined based on whether the first-type counter corresponding to the each RS resource subgroup reaches a first-type value; the target MAC CE is transmitted according to the instruction of the first uplink grant; a format of the target MAC CE is determined based on a number of RS resource subgroup(s) indicated by each of at least one candidate format in a first candidate format set, an RS resource subgroup indicated by any of the at least one candidate format in the first candidate format set is an RS resource subgroup in the first RS resource set; the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the antenna 452, the receiver 454, the receiving processor 456, the controller/processor 459 are used to receive a first signaling; at least one of the antenna 420, the transmitter 418, the transmitting processor 416, or the controller/processor 475 is used to transmit the first signaling.

In one embodiment, the antenna 452, the receiver 454, the receiving processor 456, and the controller/processor 459 are used to receive a second signaling; at least one of the antenna 420, the transmitter 418, the transmitting processor 416, or the controller/processor 475 is used to transmit a second signaling.

In one embodiment, the antenna 452, the transmitter 454, the transmitting processor 468, and the controller/processor 459 are used to transmit a target MAC CE; at least one of the antenna 420, the receiver 418, the receiving processor 470, or the controller/processor 475 is used to receive a target MAC CE.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a UE that supports large delay differences.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a base station (gNB/eNB/ng-eNB).

In one embodiment, the second communication device 410 is a UE.

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5

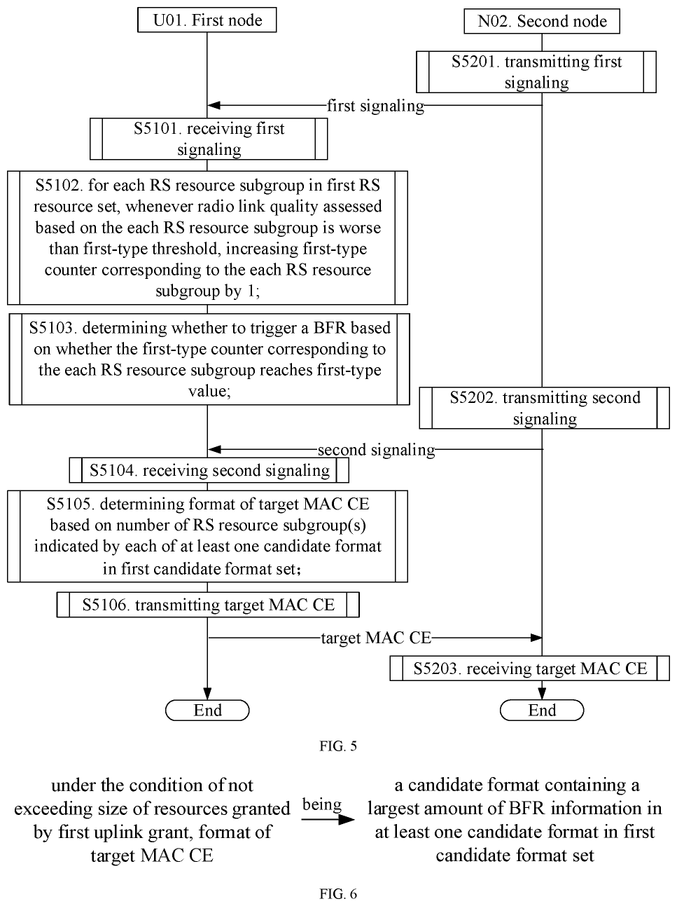

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01 , in step S5101, receives the first signaling, the first signaling indicates a first RS resource set, the first RS resource set comprises at least one RS resource group, each RS resource group in the at least one RS resource group is associated with a cell, each RS resource group in the at least one RS resource group comprises at least one RS resource subgroup, each RS resource subgroup comprises at least one RS resource; in step S5102, for each RS resource subgroup in the first RS resource set, whenever radio link quality assessed based on the each RS resource subgroup is worse than a first-type threshold, increases a first-type counter corresponding to the each RS resource subgroup by 1; in step S5103, determines whether to trigger a BFR based on whether the first-type counter corresponding to the each RS resource subgroup reaches a first-type value; in step S5104, receives a second signaling, the second signaling indicates a first uplink grant; in step S5105, determines a format of the target MAC CE based on a number of RS resource subgroup(s) indicated by each of at least one candidate format in a first candidate format set, an RS resource subgroup indicated by any of the at least one candidate format in the first candidate format set is an RS resource subgroup in the first RS resource set; in step S5106, transmits the target MAC CE according to an instruction of the first uplink grant.

The second node N02 transmits the first signaling in step S5201; in step S5202, transmits the second signaling; in step S5203, receives the target MAC CE.

In embodiment 5, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, the first node U01 comprises a UE.

In one embodiment, the first node U01 comprises a detection device.

In one embodiment, the first node U01 comprises a testing device.

In one embodiment, the second node N02 comprises at least one base station device.

In one embodiment, the second node N02 is a maintenance base station for any cell in the first cell group.

In one embodiment, the second node N02 comprises at least one TRP.

In one embodiment, the second node N02 comprises a maintenance base station for at least one serving cell.

In one embodiment, the second node N02 comprises at least one relay device.

In one embodiment, the second node N02 comprises at least one user device.

In one embodiment, the second node N02 is a maintenance base station of the first node U01.

In one embodiment, the second node N02 is at least one TRP in a maintenance base station of the first node U01.

In one embodiment, the second node N02 is a maintenance base station of an SpCell of the first node U01.

In one embodiment, the step S5102 and the step S5103 are executed for each RS resource subgroup in the first RS resource set.

In one embodiment, the step S5102 and the step S5103 are executed for each RS resource subgroup in the second RS resource set.

In one embodiment, the step S5102 and step S5103 are executed for an RS resource subgroup in an SpCell.

### Embodiment 6

Embodiment 6 illustrates a schematic diagram of a format of a target MAC CE being a candidate format with a largest amount of BFR information contained in at least one candidate format in a first candidate format set according to one embodiment of the present application, as shown in FIG. 6.

In embodiment 6, under the condition of not exceeding a size of resources granted by the first uplink grant, the format of the target MAC CE is a candidate format containing a largest amount of BFR information in the at least one candidate format in the first candidate format set.

In one embodiment, under the condition that a size of resources granted in the first uplink grant not being exceeded, the format of the target MAC CE is a candidate format with a largest amount of BFR information contained in a candidate format group; the candidate format group comprises at least one candidate format in the first candidate format set.

In one embodiment, a candidate format with a largest amount of BFR information in the first RS resource set that can be contained by the resources granted by the first uplink grant is used to determine whether the format of the target MAC CE is a complete MAC CE format or a truncated MAC CE format.

In one embodiment, if the resources granted by the first uplink grant can contain all BFR information in the first RS resource set, a candidate format with a largest amount of BFR information contained in the at least one candidate format in the first candidate format set is a complete MAC CE format, and the target MAC CE format is the complete MAC CE format.

In one embodiment, if the resources granted by the first uplink grant cannot contain all BFR information in the first RS resource set, a candidate format with a largest amount of BFR information contained in the at least one candidate format in the first candidate format set is a truncated MAC CE format, and the target MAC CE format is the truncated MAC CE format.

In one embodiment, the format of the target MAC CE being a complete MAC CE format refers to: the format of the target MAC CE comprises all BFR information in the first RS resource set.

In one embodiment, the format of the target MAC CE being a complete MAC CE format refers to: the format of the target MAC CE is not a truncated MAC CE format.

In one embodiment, if the format of the target MAC CE is a truncated MAC CE format, and under the condition of not exceeding a size of the resource granted by the first uplink, maximize an amount of BFR information contained in the target MAC CE.

In one embodiment, the format of the target MAC CE being a truncated MAC CE format refers to: the format of the target MAC CE does not comprise at least one BFR information in the first RS resource set.

In one embodiment, the format of the target MAC CE being a truncated MAC CE format refers to: the format of the target MAC CE may not comprise at least one BFR information in the first RS resource set.

In one embodiment, an amount of BFR information contained in only one of the at least one candidate format in the first candidate format set is the largest.

In one embodiment, amounts of BFR information contained in at least two candidate formats in the at least one candidate format in the first candidate format set are tied for largest, and the format of the target MAC CE is any of the at least two candidate formats.

In one embodiment, amounts of BFR information contained in at least two candidate formats in at least one candidate format in the first candidate format set are tied for largest, and the format of the target MAC CE is a candidate format with the largest number of bitmaps in the at least two candidate formats.

In one embodiment, amounts of BFR information contained in at least two candidate formats in the at least one candidate format in the first candidate format set are tied for largest, and the format of the target MAC CE is a candidate format with the smallest number of bitmap(s) in the at least two candidate formats.

In one embodiment, a number of RS resource subgroup(s) indicated by any of the at least one candidate format in the first candidate format set is used to determine the amount of BFR information contained by the any candidate format.

In one embodiment, a number of BFR(s) that can be contained by the resources granted by the first uplink grant for the any candidate format is used to determine the amount of BFR information contained by the any candidate format.

In one embodiment, an amount of BFR information in the first RS resource set is used to determine the amount of BFR information contained by the any candidate format.

In one embodiment, a number of BFR(s) that can be contained by the resources granted by the first uplink grant for the any candidate format and an amount of BFR information in the first RS resource set are used together to determine the amount of BFR information contained by the any candidate format.

In one embodiment, the meaning of the above phrase comprises: a smaller one of a number of BFR(s) that can be contained in the resources granted by the first uplink grant and an amount of BFR information in the first RS resource set is used to determine the amount of BFR information contained by the any candidate format.

In one embodiment, the meaning of the above phrase comprises: the amount of BFR information contained by the any candidate format is determined according to a smaller one of a number of BFR(s) that can be contained in the resources granted by the first uplink grant and an amount of BFR information in the first RS resource set.

In one embodiment, the meaning of the above phrase comprises: the amount of BFR information contained by the any candidate format is determined in a smaller one of a number of BFR(s) that can be contained in the resources granted by the first uplink grant and an amount of BFR information in the first RS resource set.

In one embodiment, a number of BFR(s) that can be contained by the resources granted by the first uplink grant is related to at least one of a size of a C-RNTI MAC CE, a size of a sub-header of a C-RNTI MAC CE, a size of a MAC sub-header of the candidate format or a size of a bitmap in the candidate format.

In one embodiment, a number of BFR(s) that can be contained by the resources granted by the first uplink grant is related to LCP.

In one embodiment, a number of BFR(s) that can be contained by the resources granted by the first uplink grant comprises: a number of BFR(s) that can be contained in a remaining size after the resources granted by the first uplink grant removing a size of a C-RNTI MAC CE, a size of a sub-header of the C-RNTI MAC CE, a size of a MAC sub-header of the candidate format and a size of the first bitmap.

In one embodiment, a number of BFR(s) that can be contained by the resources granted by the first uplink grant comprises: a number of BFR(s) that can be contained in a remaining size after a size of the candidate format that the resources granted by the first uplink grant capable of being used for removing a size of a MAC sub-header of the candidate format and a size of the first bitmap.

In one embodiment, the resources granted by the first uplink grant capable of being used for a size of the candidate format comprises: after the LCP process, the size of resources in the resources granted by the first uplink grant that capable of being used for the candidate format.

In one embodiment, in the present application, if a candidate format comprises a first bitmap, the size of the bitmap refers to a size of the first bitmap; if a candidate format comprises a second bitmap and a third bitmap, the size of the bitmap is a sum of a size of the second bitmap and a size of the third bitmap.

### Embodiment 7

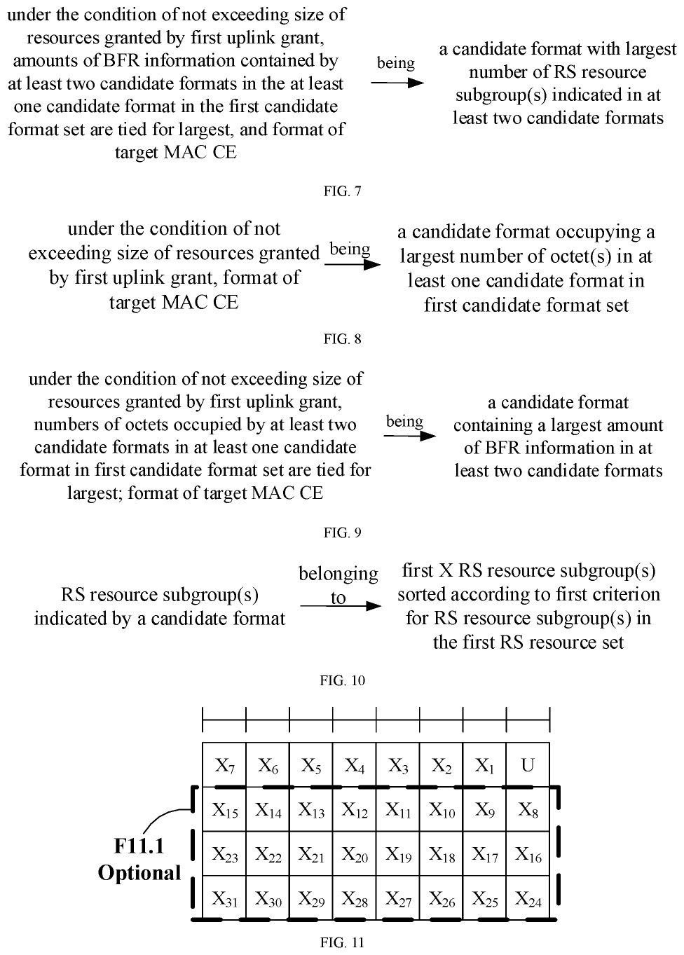

Embodiment 7 illustrates a schematic diagram of a format of a target MAC CE being a candidate format with a largest amount of BFR information contained in at least one candidate format in a first candidate format set according to another embodiment of the present application, as shown in FIG. 7.

In embodiment 7, under the condition of not exceeding a size of resources granted by the first uplink grant, amounts of BFR information contained by at least two candidate formats in the at least one candidate format in the first candidate format set are tied for largest; the format of the target MAC CE is a candidate format with a largest number of RS resource subgroup(s) indicated in the at least two candidate formats.

In one embodiment, a number of RS resource subgroup(s) indicated by any of the at least one candidate format in the first candidate format set is used to determine the amount of BFR information contained by the any candidate format.

In one embodiment, an amount of BFR information that can be contained by the resources granted by the first uplink grant for the any candidate format is used to determine the amount of BFR information contained by the any candidate format.

In one embodiment, an amount of BFR information in the first RS resource set is used to determine the amount of BFR information contained by the any candidate format.

In one embodiment, an amount of BFR information that can be contained by the resources granted by the first uplink grant for the any candidate format and an amount of BFR information in the first RS resource set are used to determine the amount of BFR information contained by the any candidate format.

In one embodiment, the phrase that the format of the target MAC CE is a candidate format with a largest number of RS resource subgroup(s) indicated in the at least two candidate formats comprises: the format of the target MAC CE is a candidate format with a largest bitmap size in the at least two candidate formats.

In one embodiment, under the condition of not exceeding a size of resources granted by the first uplink grant, if an amount of BFR information contained in only one of the at least one candidate format in the first candidate format set is the largest, the format of the target MAC CE is the only one candidate format; if amounts of BFR information contained in at least two candidate formats in the at least one candidate format in the first candidate format set are tied for largest, the format of the target MAC CE is a candidate format with a largest number of RS resource subgroup(s) indicated in the at least two candidate formats.

In one embodiment, under the condition of not exceeding a size of resources granted by the first uplink grant, if numbers of RS resource subgroups indicated by at least two candidate formats in at least one candidate format in the first candidate format set are tied for largest, the format of the target MAC CE is a candidate format with a largest amount of BFR information contained in the at least two candidate formats.

In one embodiment, under the condition of not exceeding a size of resources granted by the first uplink grant, if the numbers of RS resource subgroups indicated by at least two candidate formats in at least one candidate format in the first candidate format set are tied for smallest, the format of the target MAC CE is a candidate format with a largest amount of BFR information contained in the at least two candidate formats.

In one embodiment, under the condition that a size of resources granted by the first uplink grant is not exceeded, if RS resource subgroups indicated by at least two candidate formats (for clarity of presentation, the at least two candidate formats of the at least one candidate format are referred to as candidate format group #1) in at least one candidate format in the first candidate format set are tied for largest, and amounts of BFR information contained in at least two candidate formats (for clarity of presentation, the at least two candidate formats in the candidate format group #1 are referred to as candidate format group #2) in the candidate format group #1 are tied for largest, and the format of the target MAC CE is a candidate format with a largest number of RS resource subgroup(s) indicated in the candidate format group #2.

In one embodiment, under the condition that a size of resources granted by the first uplink grant is not exceeded, if numbers of RS resource subgroups indicated by at least two candidate formats (for clarity of presentation, the at least two candidate formats in the at least one candidate format are referred to as candidate format group #1) in at least one candidate format in the first candidate format set are tied for smallest, and amounts of BFR information contained in at least two candidate formats (for clarity of presentation, the at least two candidate formats of the candidate format group #1 are referred to as candidate format group #2) in the candidate format group #1 are tied for largest, and the format of the target MAC CE is a candidate format with a largest number of RS resource subgroup(s) indicated in the candidate format group #2.

### Embodiment 8

Embodiment 8 illustrates a schematic diagram of a format of a target MAC CE being a candidate format with a largest number of octet(s) occupied in at least one candidate format in a first candidate format set according to one embodiment of the present application, as shown in FIG. 8.

In embodiment 8, under the condition of not exceeding a size of resources granted by the first uplink grant, the format of the target MAC CE is a candidate format with a largest number of octet(s) occupied in the at least one candidate format in the first candidate format set.

In one embodiment, under the condition of not exceeding a size of resources granted by the first uplink grant, the format of the target MAC CE is a candidate format with a largest number of octet(s) occupied in a candidate format group; herein, the candidate format group comprises at least one candidate format in the first candidate format set.

In one embodiment, a number of RS resource subgroup(s) indicated by any of the at least one candidate format in the first candidate format set is used to determine the number of octet(s) occupied by the any candidate format.

In one embodiment, the phrase that a number of RS resource subgroup(s) indicated by any of the at least one candidate format in the first candidate format set is used to determine the number of octet(s) occupied by the any candidate format comprises: the number of octet(s) occupied by any candidate format is related to a number of RS resource subgroup(s) indicated by any candidate format in at least one candidate format in the first candidate format set.

In one embodiment, the number of octet(s) occupied by a candidate format is related to at least one of a bitmap in the candidate format, BFR information in the candidate format, or a MAC sub-header in the candidate format.

In one embodiment, the number of octet(s) occupied by a candidate format is related to the size of the resources granted by the first uplink grant.

In one embodiment, the number of octet(s) occupied by a candidate format is related to a number of RS resource subgroup(s) indicated by the candidate format.

In one embodiment, the number of octet(s) occupied by a candidate format is related to the size of the resources granted by the first uplink grant.

In one embodiment, the number of octet(s) occupied by a candidate format comprises: a sum of a number of octet(s) occupied by a bitmap in the candidate format and a number of octet(s) occupied by BFR information in the candidate format.

In one embodiment, the number of octet(s) occupied by a candidate format comprises: a sum of a number of octet(s) occupied by a MAC sub-header in the candidate format, a number of octet(s) occupied by a bitmap in the candidate format, and a number of octet(s) occupied by BFR information in the candidate format.

In one embodiment, a number of octet(s) occupied by the MAC sub-header in the candidate format refers to a number of octet(s) used for the MAC sub-header in the candidate format.

In one embodiment, a number of octet(s) occupied by the MAC sub-header of the candidate format is not greater than 6.

In one embodiment, a number of octet(s) occupied by the MAC sub-header of the candidate format is equal to 5.

In one embodiment, a number of octet(s) occupied by the MAC sub-header of the candidate format is equal to 3.

In one embodiment, a number of octet(s) occupied by the MAC sub-header of the candidate format is equal to 4.

In one embodiment, a number of octet(s) occupied by a bitmap in the candidate format refers to a number of octet(s) used for the bitmap in the candidate format.

In one embodiment, if a candidate format comprises a first bitmap, a number of octet(s) occupied by a bitmap in the candidate format refers to a number of octet(s) occupied by the first bitmap; if a candidate format comprises a second bitmap and a third bitmap, a number of octet(s) occupied by a bitmap in the candidate format refers to a sum of a number of octet(s) occupied by the second bitmap and a number of octet(s) occupied by the third bitmap.

In one embodiment, a number of octet(s) occupied by BFR information in the candidate format is equal to an amount of BFR information comprised in the candidate format.

In one embodiment, a number of octet(s) occupied by BFR information in the candidate format refers to a number of octet(s) used for BFR information in the candidate format.

In one embodiment, the octet refers to octet.

In one embodiment, the octet comprises 8 continuous bits.

In one embodiment, the octet comprises 8 continuous bits.

In one embodiment, the octet comprises one byte.

In one embodiment, the octet is byte aligned.

In one embodiment, the phrase that the format of the target MAC CE is a candidate format occupying a largest number of octet(s) occupied by the at least one candidate format in the first candidate format set comprises: the format of the target MAC CE is a candidate format with a largest size of a bitmap in the at least one candidate format in the first candidate format set.

### Embodiment 9

Embodiment 9 illustrates a schematic diagram of a format of a target MAC CE being a candidate format with a largest number of octet(s) occupied in at least one candidate format in a first candidate format set according to another embodiment of the present application, as shown in FIG. 9.

In embodiment 9, under the condition of not exceeding a size of resources granted by the first uplink grant, numbers of octets occupied by at least two candidate formats in the at least one candidate format in the first candidate format set are tied for largest; the format of the target MAC CE is a candidate format containing a largest amount of BFR information in the at least two candidate formats.

In one embodiment, a number of RS resource subgroup(s) indicated by any of the at least one candidate format in the first candidate format set is used to determine the number of octet(s) occupied by the any of the candidate format.

In one embodiment, under the condition of not exceeding a size of resources granted by the first uplink grant, numbers of octets occupied by at least two candidate formats in the at least one candidate format in the first candidate format set are tied for largest; the format of the target MAC CE is a candidate format containing a largest amount of BFR information in the at least two candidate formats; a number of RS resource subgroup(s) indicated by any of the at least one candidate format in the first candidate format set is used to determine the number of octet(s) occupied by the any candidate format.

In one embodiment, if numbers of octets occupied by at least two candidate formats in a candidate format group are tied for largest, the format of the target MAC CE is a candidate format with a largest amount of BFR information contained in the at least two candidate formats; the candidate format group comprises at least one candidate format in the first candidate format set.

In one embodiment, under the condition that a size of resources granted by the first uplink grant is not exceeded, if numbers of RS resource subgroups indicated by at least two candidate formats (for clarity of presentation, the at least two candidate formats of the at least one candidate format are referred to as candidate format group 190 1) in at least one candidate format in the first candidate format set are tied for largest, and a number of octet(s) occupied by at least two candidate formats (for clarity of presentation, the at least two candidate formats in the candidate format group #1 are referred to as candidate format group #2) in the candidate format group #1 are tied for largest, and the format of the target MAC CE is a candidate format with a largest amount of BFR information contained in in the candidate format group #2.

In one embodiment, under the condition that a size of resources granted by the first uplink grant is not exceeded, if numbers of RS resource subgroups indicated by at least two candidate formats (for clarity of presentation, the at least two candidate formats of the at least one candidate format are referred to as candidate format group #1) in at least one candidate format in the first candidate format set are tied for smallest, and a number of octet(s) occupied by at least two candidate formats (for clarity of presentation, the at least two candidate formats in the candidate format group #1 are referred to as candidate format group #2) in the candidate format group #1 are tied for largest, and the format of the target MAC CE is a candidate format with a largest amount of BFR information contained in in the candidate format group #2.

### Embodiment 10

Embodiment 10 illustrates a schematic diagram of RS resource subgroup(s) indicated by one candidate format belonging to first H RS resource subgroup(s) sorted according to a first criterion for RS resource subgroup(s) in a first RS resource set according to one embodiment of the present application, as shown in FIG. 10.

In embodiment 10, BFR information contained in any of the at least one candidate format in the first candidate format set belongs to first H RS resource subgroup(s) sorted according to a first criterion for RS resource subgroup(s) in the first RS resource set, and the first criterion comprises sorting at least according to a cell identity of an associated cell.

In one embodiment, H is a positive integer not less than 8.

In one embodiment, H is an integer not greater than 31.

In one embodiment, H is an integer not greater than 62.

In one embodiment, H is an integer not greater than 8.

In one embodiment, H is an integer not greater than 16.

In one embodiment, H is determined based on the size of the resources granted by the first uplink grant, the format of the target MAC CE, and a number of RS resource subgroup(s) in the first RS resource set.

In one embodiment, the H is equal to the amount of BFR information contained in the format of the target MAC CE.

In one embodiment, under the condition of not exceeding a size of resources granted by the first uplink grant, BFR information contained in any of the at least one candidate format in the first candidate format set belongs to first H RS resource subgroup(s) sorted according to a first criterion for RS resource subgroup(s) in the first RS resource set, and the first criterion comprises sorting at least according to a cell identity of an associated cell.

In one embodiment, the first H RS resource subgroup(s) comprises(comprise) each RS resource subgroup in the first RS resource set.

In one embodiment, the first H RS resource subgroup(s) does(do) not comprise at least one RS resource subgroup in the first RS resource set.

In one embodiment, the phrase of sorting according to a cell identity of an associated cell comprises: sorting according to a size of the cell identity of a cell associated with each RS resource subgroup in the first RS resource set.

In one embodiment, the phrase of sorting according to a cell identity of an associated cell comprises: sorting in an ascending order according to the cell identity of a cell associated with each RS resource subgroup in the first RS resource set.

In one embodiment, if a cell identity of a cell associated with an RS resource subgroup is smaller than a cell identity of a cell associated with another RS resource subgroup, the BFR information of the RS resource subgroup is located before an RS resource group to which the another RS resource subgroup belongs.

In one embodiment, the first criterion comprises sorting based on whether an RS resource group to which an RS resource subgroup belongs comprises an RS resource subgroup without BFR.

In one subembodiment of the embodiment, if an RS resource group to which an RS resource subgroup belongs does not comprise an RS resource subgroup without BFR, and an RS resource group to which another RS resource subgroup belongs comprises an RS resource subgroup without BFR, BFR information of the RS resource subgroup is located before an RS resource group to which the another RS resource subgroup belongs.

In one subembodiment of the embodiment, if an RS resource group to which one RS resource subgroup belongs does not comprise an RS resource subgroup without BFR, and an RS resource group to which another RS resource subgroup belongs comprises an RS resource subgroup without BFR, BFR information of the RS resource subgroup is located after an RS resource group to which the another RS resource subgroup belongs.

In one embodiment, the first criterion comprises sorting based on a number of RS resource subgroup(s) comprised in an RS resource group to which an RS resource subgroup belongs.

In one subembodiment of the embodiment, if a number of RS resource subgroup(s) comprised in an RS resource group to which an RS resource subgroup belongs is equal to 1, and a number of RS resource subgroup(s) comprised in an RS resource group to which another RS resource subgroup belongs is equal to 2, BFR information of the RS resource subgroup is located before an RS resource group to which the another RS resource subgroup belongs.

In one subembodiment of the embodiment, if a number of RS resource subgroup(s) comprised in an RS resource group to which an RS resource subgroup belongs is equal to 1, and a number of RS resource subgroup(s) comprised in an RS resource group to which another RS resource subgroup belongs is equal to 2, BFR information of the RS resource subgroup is located after an RS resource group to which the another RS resource subgroup belongs.

In one embodiment, the first criterion comprises sorting according to type of RS resource subgroup(s) in an RS resource group.

In one subembodiment of the embodiment, if an RS resource subgroup is the first-type RS resource subgroup and another RS resource subgroup is the second-type RS resource subgroup, BFR information of the RS resource subgroup is located before an RS resource group to which the another RS resource subgroup belongs.

In one subembodiment of the embodiment, if an RS resource subgroup is the first-type RS resource subgroup and another RS resource subgroup is the second-type RS resource subgroup, BFR information of the RS resource subgroup is located after an RS resource group to which the another RS resource subgroup belongs.

In one subembodiment of the embodiment, if an RS resource subgroup is indicated by the second bitmap and another RS resource subgroup is indicated by the third bitmap, BFR information of the RS resource subgroup is located before an RS resource group to which the another RS resource subgroup belongs.

In one embodiment, the first criterion comprises, for any two RS resource subgroups in the first RS resource set, preferentially ordering according to whether an RS resource group to which the any two RS resource subgroups belong comprises an RS resource subgroup without a BFR; if an RS resource group to which the any two RS resource subgroups belong comprises an RS resource subgroup without BFR, or if an RS resource group to which the any two RS resource subgroups belong does not comprise an RS resource subgroup without BFR, then sorting is done in accordance with a cell identity of its associated cell; if cell identities of cells associated with the any two RS resource subgroups are the same, sorting is done according to type of an RS resource subgroup in an RS resource group.

In one embodiment, the first criterion comprises, for any two RS resource subgroups in the first RS resource set, preferentially ordering in accordance with whether an RS resource group to which the any two RS resource subgroups belong comprises an RS resource subgroup without a BFR; if an RS resource group to which each RS resource subgroup in the any two RS resource subgroups comprises an RS resource subgroup without BFR, or, an RS resource group to which each RS resource subgroup in the any two RS resource subgroups does not comprise an RS resource subgroup without BFR, and sorting is done according to a number of RS resource subgroup(s) comprised in an RS resource group to which an RS resource subgroup belongs; if a number of RS resource subgroup(s) comprised in an RS resource group to which each RS resource subgroup of the any two RS resource subgroups belongs is equal, then sorting is done in accordance with a cell identity of its associated cell; if cell identities of cells associated with the any two RS resource subgroups are the same, sorting is done according to type of an RS resource subgroup in an RS resource group.

In one embodiment, the first criterion comprises, for any two RS resource subgroups in the first RS resource set, prioritizing the ordering according to a cell identity of its associated cell, and if cell identities of cells associated with the any two RS resource subgroups are the same, then sorting is done according to type of an RS resource subgroup in an RS resource set.

In one embodiment, the first criterion comprises sorting according to at least one of a cell identity of a cell associated with an RS resource subgroup, or whether an RS resource subgroup to which an RS resource subgroup belongs comprises an RS resource subgroup without BFR, or a number of RS resource subgroup(s) comprised in an RS resource subgroup to which an RS resource subgroup belongs, or a type of an RS resource subgroup in an RS resource group.

In one embodiment, an RS resource subgroup indicated by any of the at least one candidate format in the first candidate format set is all RS resource subgroups excluding an RS resource subgroup associated with an SPcell in the first H RS resource subgroup(s).

In one embodiment, an RS resource subgroup indicated by any of the at least one candidate format in the first candidate format set is all RS resource subgroups associated with an Scell in the first H RS resource subgroup(s).

### Embodiment 11

Embodiment 11 illustrates a schematic diagram of a first bitmap according to one embodiment of the present application, as shown in FIG. 11. In FIG. 11, each row represents an octet, and each box represents a bit.

In one embodiment, the first bitmap is a bitmap.

In one embodiment, the first bitmap comprises a first specific field, and the first specific field indicates the SpCell.

In one embodiment, each bit in the first bitmap indicates an RS resource subgroup.

In one embodiment, each bit in the first bitmap indicates an RS resource group.

In one embodiment, U in the first bitmap corresponds to an SpCell.

In one embodiment, one bit in the first bitmap is used to indicate whether an RS resource group corresponding to the bit comprises an RS resource subgroup having BFR.

In one subembodiment of the embodiment, if an RS resource group comprises an RS resource subgroup having BFR, set a bit corresponding to the RS resource group in the first bitmap to 1; otherwise set it to 0.

In one embodiment, the first specific field is the U field.

In one embodiment, the U field is an SP field.

In one embodiment, the box F11.1 framed with dotted lines is optional.

In one embodiment, the box F11.1 framed with dotted lines exists.

In one subembodiment of the embodiment, a length of the first bitmap is equal to 4 bytes.

In one subembodiment of the above embodiment, the X₁, . . . , and X ₃₁ are C₁, . . . , and C₃₁, respectively.

In one subembodiment of the above embodiment, the X₁, . . . , and X₃₁ are T₁, . . . , and T₃₁, respectively.

In one subembodiment of the embodiment, X₁, . . . , and X₃₁ in the first bitmap correspond to cells with ServCellIndex equal to 1, . . . , and 31, respectively.

In one subembodiment of the embodiment, X₁ . . . X₃₁ in the first bitmap correspond to RS resource groups corresponding to cells with ServCellIndex equal to 1, . . . , and 31, respectively.

In one embodiment, the box F11.1 framed with dotted lines does not exist.

In one subembodiment of the embodiment, a length of the first bitmap is equal to 1 byte.

In one subembodiment of the above embodiment, the X₁, . . . , and X₇ are C₁, . . . , and C₇, respectively.

In one subembodiment of the above embodiment, the X₁, . . . , and X₇ are T₁, . . . , and T₇, respectively.

In one subembodiment of the embodiment, X₁, . . . , and X₇ in the first bitmap correspond to cells with ServCellIndex equal to 1, . . . , and 7, respectively.

In one subembodiment of the embodiment, X₁ . . . X₇ in the first bitmap correspond to RS resource groups corresponding to cells with ServCellIndex equal to 1, . . . , and 7, respectively.

### Embodiment 12

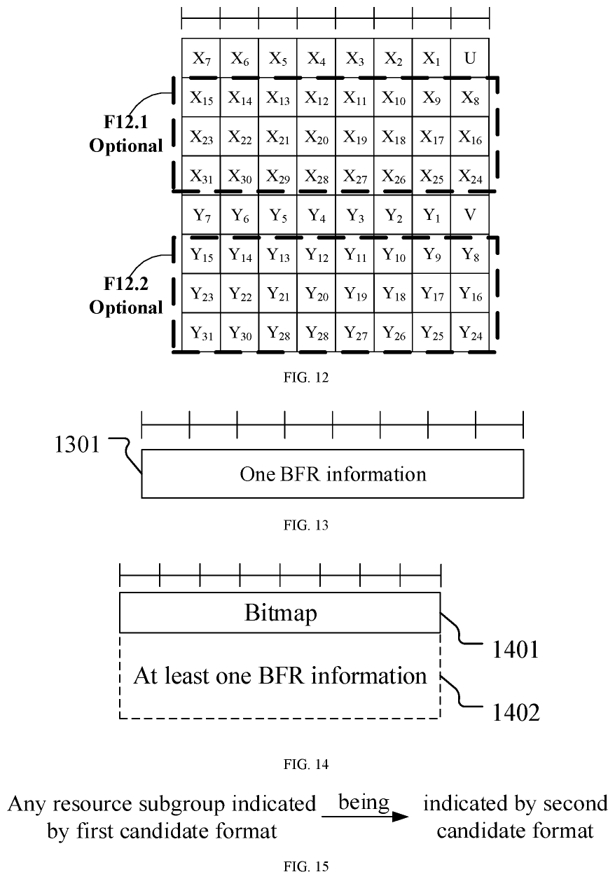

Embodiment 12 illustrates a schematic diagram of a second bitmap and a third bitmap according to one embodiment of the present application, as shown in FIG. 12. In FIG. 12, each row represents an octet, and each box represents a bit.

In one embodiment, a size of the second bitmap and a size of the third bitmap are equal.

In one embodiment, a size of the second bitmap and a size of the third bitmap are not equal.

In one embodiment, the second bitmap comprises a second specific field, the third bitmap comprises a third specific field, and at least a former in the second specific field or the third specific field indicates the SpCell.

In one embodiment, a length of the second specific field is equal to 1 bit.

In one embodiment, the second specific field is the U field, and the third specific field is the V field.

In one embodiment, a name of the U field comprises SP.

In one embodiment, a name of the V field comprises SP.

In one embodiment, one bit in the second bitmap is used to indicate whether an RS resource group corresponding to the bit comprises an RS resource subgroup having BFR; another bit in the third bitmap is used to indicate whether an RS resource group corresponding to the bit in the second bitmap comprises an RS resource subgroup without BFR.

In one subembodiment of the embodiment, if an RS resource group comprises an RS resource subgroup having BFR, set a bit corresponding to the RS resource group in the second bitmap to 1; otherwise set it to 0; if the RS resource group does not comprise an RS resource subgroup without BFR, set a bit corresponding to the RS resource group in the third bitmap to 1, otherwise set it to 0.

In one embodiment, one bit in the second bitmap is used to indicate whether an RS resource subgroup in an RS resource group corresponding to the bit has BFR; another bit in the third bitmap is used to indicate whether another RS resource subgroup in an RS resource group corresponding to the bit in the second bitmap has BFR.

In one subembodiment of the embodiment, if an RS resource subgroup in an RS resource group has BFR, set a bit corresponding to the RS resource group in the second bitmap to 1, otherwise set it to 0; if another RS resource subgroup in the RS resource group has BFR, set a bit corresponding to the RS resource group in the third bitmap to 1, otherwise set it to 0.

In one embodiment, the dotted box F12.1 does not exist, and the dotted box F12.2 does not exist.

In one subembodiment of the embodiment, the first bitmap comprises a second bitmap and a third bitmap, the second bitmap comprising one byte, and the third bitmap comprising one byte.

In one subembodiment of the embodiment, X₁, . . . , and X₇ in the second bitmap correspond to cells with ServCellIndex equal to 1, . . . , and 7, respectively.

In one subembodiment of the embodiment, Y₁, . . . , and Y₇ in the third bitmap correspond to cells with ServCellIndex equal to 1, . . . , and 7, respectively.

In one embodiment, the dotted box F12.1 exists, and the dotted box F12.2 exists.

In one subembodiment of the embodiment, X₁, . . . , and X₃₁ in the second bitmap correspond to cells with ServCellIndex equal to 1, . . . , and 31, respectively.

In one subembodiment of the embodiment, Y₁, . . . , and Y₃₁ in the third bitmap correspond to cells with ₁₃₁

ServCellIndex equal to 1, . . . , and 31, respectively.

In one embodiment, the dotted box F12.1 exists, and all or part of the dotted box F12.2 does not exist.

In one subembodiment of the embodiment, X₁, . . . , and X₃₁ in the second bitmap correspond to cells with ServCellIndex equal to 1, . . . , and 31, respectively.

In one subembodiment of the embodiment, Y₁, . . . , and Y_{M2} in the third bitmap correspond to the cells associated with the bits set to 1 in the second bitmap.

In one subembodiment of the embodiment, Y₁, . . . , and Y_{M3} in the third bitmap correspond to cells associated with the bits set to 1 in the second bitmap, and the M3 is a non-negative integer not greater than M2.

In one subembodiment of the embodiment, a size of the third bitmap is variable.

In one subembodiment of the embodiment, the second bitmap is used to determine a size of the third bitmap.

In one embodiment, a bit indicating a cell is equivalent to a bit indicating an RS resource group associated to the cell.

In one embodiment, a bit indicating a cell is equivalent to a bit indicating an RS resource group associated to the cell.

### Embodiment 13

Embodiment 13 illustrates a schematic diagram of BFR information according to one embodiment of the present application, as shown in FIG. 13. In FIG. 13, the box 1301 represents BFR information, and the BFR information comprises at least one byte.

In one embodiment, the BFR information is used to indicate beam failure information.

In one embodiment, the BFR information corresponds to an RS resource subgroup.

In one embodiment, the BFR information occupies an octet.

In one embodiment, the BFR information occupies two octets.

In one embodiment, the BFR information refers to an octet containing an AC field.

In one embodiment, the target MAC CE comprises BFR information for each RS resource subgroup in the first RS resource set.

In one embodiment, the target MAC CE does not comprise BFR information for at least one RS resource subgroup in the first RS resource set.

In one embodiment, the BFR information comprises at least a first MAC field and a second MAC field; the first MAC field in the BFR information indicates whether the second MAC field in the BFR information exists; if the first MAC field in the BFR information indicates an existence of the second MAC field in the BFR information, and the second MAC field in the BFR information indicates a candidate RS resource, and the candidate RS resource is associated with the RS resource subgroup corresponding to the BFR information; if the first MAC field in the BFR information indicates that the second MAC field in the BFR information does not exist, the second MAC field in the BFR information is reserved.

In one subembodiment of the embodiment, the first MAC field is an AC field, and the second MAC field is a candidate RS ID field.

In one subembodiment of the embodiment, a length of the first MAC field is equal to 1 bit, and a length of the second MAC field is equal to 6 bits.

In one subembodiment of the embodiment, a length of the first MAC field is equal to 1 bit, and a length of the second MAC field is equal to 5 bits.

In one subembodiment of the embodiment, the BFR information comprises a third MAC field, and the third MAC field is reserved.

In one subembodiment of the embodiment, the BFR information comprises a third MAC field, and the third MAC field is used to indicate an RS resource subgroup corresponding to the BFR information.

In one subembodiment of the above embodiment, a length of the third MAC field is equal to 1 bit.

In one subembodiment of the above embodiment, a length of the third MAC field is equal to 2 bits.

In one subembodiment of the above embodiment, the BFR information consists of the first MAC field, the second MAC field, and the third MAC field.

In one subembodiment of the above embodiment, the first MAC field is located before the third MAC field, and the third MAC field is located before the second MAC field.

In one subembodiment of the above embodiment, the BFR information consists of the first MAC field, the second MAC field, the third MAC field, and the fourth MAC field.

In one subembodiment of the above embodiment, the first MAC field is located before the third MAC field, the third MAC field is located before the fourth MAC field, and the fourth MAC field is located before the second MAC field.

### Embodiment 14

Embodiment 14 illustrates a schematic diagram of a format of a target MAC CE according to one embodiment of the present application, as shown in FIG. 14. In FIG. 14, the box 1401 represents a bitmap in a target MAC CE, and the box 1402 represents at least one BFR information in a target MAC CE.

In embodiment 14, the target MAC CE comprises at least a former in at least one bitmap and at least one BFR information.

In one embodiment, the at least one bitmap comprises the first bitmap; a number of bitmap(s) in the at least one bitmap is equal to 1.

In one embodiment, the at least one bitmap comprises the second bitmap and a third bitmap; a number of bitmap(s) in the at least one bitmap is equal to 2.

In one embodiment, the target MAC CE consists of at least a former in the at least one bitmap and at least one BFR information.

In one embodiment, the target MAC CE consists of the first bit bitmap.

In one embodiment, the target MAC CE consists of the first bit bitmap and at least one BFR information.

In one embodiment, the target MAC CE consists of the second bitmap and a third bitmap.

In one embodiment, the target MAC CE consists of the second bitmap, a third bitmap and the at least one BFR information.

In one embodiment, the target MAC CE comprises at least one BFR information.

In one embodiment, the target MAC CE does not comprise any BFR information.

In one embodiment, the at least one BFR information comprised in the target MAC CE is BFR information of first H RS resource subgroup(s) determined according to the first criterion.

In one embodiment, the box 1402 is optional.

In one embodiment, the box 1402 exists.

In one embodiment, the box 1402 does not exist.

### Embodiment 15

Embodiment 15 illustrates a schematic diagram of any RS resource subgroup indicated by a first candidate format being indicated by a second candidate format according to one embodiment of the present application, as shown in FIG. 15.

In embodiment 15, any RS resource subgroup indicated by the first candidate format is indicated by the second candidate format, and at least one RS resource subgroup having BFR indicated by the second candidate format is not indicated by the first candidate format.

In one embodiment, a size of a bitmap in the first candidate format being less than a size of a bitmap in the second candidate format is used to determine that any RS resource subgroup indicated by the first candidate format is indicated by the second candidate format, and at least one RS resource subgroup having BFR indicated by the second candidate format is not indicated by the first candidate format.

In one embodiment, a bitmap in the first candidate format cannot be used to determine an RS resource subgroup, a bitmap in the second candidate format being used to determine an RS resource subgroup is used to determine that any RS resource subgroup indicated by the first candidate format is indicated by the second candidate format, and at least one RS resource subgroup having BFR indicated by the second candidate format is not indicated by the first candidate format.

In one embodiment, the first candidate format is a truncated MAC CE format, the second candidate format being a complete MAC CE format is used to determine that any RS resource subgroup indicated by the first candidate format is indicated by the second candidate format, and at least one RS resource subgroup having BFR indicated by the second candidate format is not indicated by the first candidate format.

### Embodiment 16

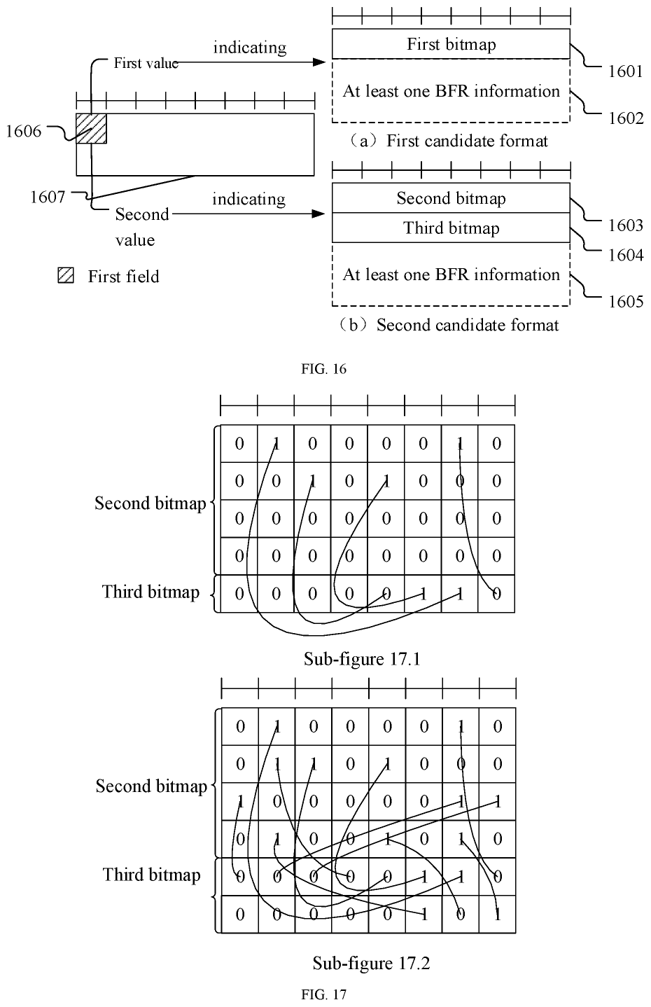

Embodiment 16 illustrates a schematic diagram of a first field in a MAC sub-header indicating whether a target MAC CE comprises a third bitmap according to one embodiment of present application, as shown in FIG. 16. In FIG. 16, the box 1601 represents a second bitmap, the box 1602 represents at least one BFR information, the box 1603 represents a second bitmap, the box 1604 represents a third bitmap, the box 1605 represents at least one BFR information, the box 1607 represents a MAC sub-header, and the box 1606 represents a first field in the MAC sub-header.

In one embodiment, the first field being set as the first value indicates the first candidate format, and the first field being set as the second value indicates the second candidate format; the first candidate format comprises one bitmap, and the second candidate format comprises two bitmaps.

In one embodiment, the first field being set as the first value indicates the first candidate format, and the first field being set as the second value indicates the second candidate format; the first candidate format comprises the first bitmap, and the second candidate format comprises the second bitmap and the third bitmap.

In one embodiment, the first candidate format and the second candidate format have a same LCID.

In one embodiment, a LCID field in a MAC sub-header corresponding to the first candidate format and the second candidate format is set to 50.

In one embodiment, a LCID field in a MAC sub-header corresponding to the first candidate format and the second candidate format is set to 51.

In one embodiment, an eLCID field in a MAC sub-header corresponding to the first candidate format and the second candidate format is set to 250.

In one embodiment, an eLCID field in a MAC sub-header corresponding to the first candidate format and the second candidate format is set to 251.

In one embodiment, a LCID field in a MAC sub-header corresponding to the first candidate format and the second candidate format is set to a value other than 50 and 51.

In one embodiment, an eLCID field in a MAC sub-header corresponding to the first candidate format and the second candidate format is set to a value other than 250 and 251.

In one embodiment, the first candidate format is the candidate format A1, and the second candidate format is the candidate format A3.

In one embodiment, the first candidate format is the candidate format A1, and the second candidate format is the candidate format A5.

In one embodiment, the first candidate format is the candidate format A2, and the second candidate format is the candidate format A4.

In one embodiment, the first candidate format is the candidate format A2, and the second candidate format is the candidate format A6.

In one embodiment, the behavior of “determining a format of a target MAC CE according to a number of RS resource subgroup(s) indicated by each of at least one candidate format in a first candidate format set” comprises: the format of the target MAC CE is determined based on a number of RS resource subgroup(s) respectively indicated by the first candidate format and second candidate format; herein, the at least one candidate format in the first candidate format set is the first candidate format and the second candidate format; the first candidate format only comprises a second bitmap, and the second candidate format comprises both the second bitmap and the third bitmap.

In one subembodiment of the embodiment, in the first candidate format, if one bit in the second bitmap is set to 1, it indicates that there exists and only exists BFR information associated with an RS resource group or an RS resource subgroup indicated by the bit in the first candidate format.

In one embodiment, the box 1602 is optional.

In one embodiment, the box 1605 is optional.

In one embodiment, the box 1602 exists.

In one embodiment, the box 1602 does not exist.

In one embodiment, the box 1605 exists.

In one embodiment, the box 1605 does not exist.

### Embodiment 17

Embodiment 17 illustrates a schematic diagram of a second bitmap being used to determine a size of a third bitmap according to one embodiment of the present application, as shown in FIG. 17.

In one embodiment, a number of bits set to 1 in the second bitmap is used to determine a size of the third bitmap.

In one embodiment, a number of significant bits in the third bitmap is equal to a cell associated with a bit set to 1 in the second bitmap.

In one embodiment, significant bits of the third bitmap are sorted in an ascending order according to cell ID(s) of cell(s) associated with bit(s) set to 1 in the second bitmap.

In one subembodiment of the embodiment, the behavior of “determining a size of the third bitmap in the target MAC CE according to the number of RS resource group(s) indicated by the second candidate format” comprises: determining a size of the third bitmap in the second candidate format based on a number of bit(s) set to 1 in the second bitmap in the second candidate format.

In one subembodiment of the embodiment, if the number of RS resource groups indicated by the second candidate format is greater than 1 and not greater than 8, the size of the third bitmap in the second candidate format is equal to 1; if the number of RS resource groups indicated by the second candidate format is greater than 8 and not greater than 16, the size of the third bitmap in the second candidate format is equal to 2; if the number of RS resource groups indicated by the second candidate format is greater than 16 and not greater than 24, the size of the third bitmap in the second candidate format is equal to 3; if the number of RS resource groups indicated by the second candidate format is greater than 24 and not greater than 32, the size of the third bitmap in the second candidate format is equal to 4.

In one subembodiment of the embodiment, if the number of RS resource groups indicated by the second candidate format is greater than 1 and not greater than 7, the size of the third bitmap in the second candidate format is equal to 1; if the number of RS resource groups indicated by the second candidate format is greater than 7 and not greater than 15, the size of the third bitmap in the second candidate format is equal to 2; if the number of RS resource groups indicated by the second candidate format is greater than 15 and not greater than 23, the size of the third bitmap in the second candidate format is equal to 3; if the number of RS resource groups indicated by the second candidate format is greater than 23 and not greater than 31, the size of the third bitmap in the second candidate format is equal to 4.

In one embodiment, the number of RS resource group(s) indicated by the second candidate format refers to: a number in the second bitmap being set to 1.

In one embodiment, the number of RS resource group(s) indicated by the second candidate format refers to: the first RS resource set comprises a number of RS resource group(s) having a BFR in RS resource subgroup(s).

In one embodiment, the number of RS resource group(s) indicated by the second candidate format is not greater than a number of RS resource group(s) having BFR in RS resource subgroup(s) in the first RS resource set.

In one embodiment, the number of RS resource group(s) indicated by the second candidate format is a positive integer.

In one embodiment, the number of RS resource group(s) indicated by the second candidate format is variable.

In one embodiment, as shown in subfigure 17.1, X₁, X₆, X₁₁, and X₁₃ in the second bitmap are set to 1, a number of bits set to 1 in the second bitmap is 4, and a length of the third bitmap is 1 byte, in the third bitmap, Y₁ corresponds to X₁, Y₂ corresponds to X₆, Y₃ corresponds to X₁₁, and Y₄ corresponds to X₁₃.

In one embodiment, as shown in subfigure 17.2, X₁, X₆, X₁₁, X₁₃, X₁₄, X₁₆, X₁₇, X₂₃, X₂₅, X₂₇, and X₃₀ in the second bitmap are set to 1, a number of bits set to 1 in the second bitmap is equal to 11, and a length of the third bitmap is equal to 1 byte, in the third bitmap, Y₁ corresponds to X₁, Y₂ corresponds to X₆, Y₃ corresponds to X₁₁, Y₄ corresponds to X₁₃, Y₅ corresponds to X₁₄, Y₆ corresponds to X₁₆, Y₇ corresponds to X₁₇, Y₈ corresponds to X₂₃, Y₉ corresponds to X₂₅, Y₁₀ corresponds to X₂₇, and Y₁₁ corresponds to X₃₀.

### Embodiment 18

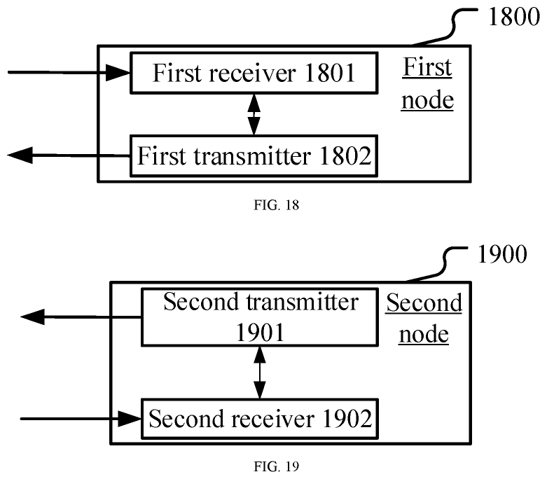

Embodiment 18 illustrates a structure block diagram of a processor in a first node according to one embodiment of the present application, as shown in FIG. 18. In FIG. 18, a processor 1800 of a first node comprises a first receiver 1801 and a first transmitter 1802.

The first receiver 1801 receives a first signaling, the first signaling indicates a first RS resource set, the first RS resource set comprises at least one RS resource group, each RS resource group in the at least one RS resource group is associated with a cell, each RS resource group in the at least one RS resource group comprises at least one RS resource subgroup, each RS resource subgroup comprises at least one RS resource; for each RS resource subgroup in the first RS resource set, whenever radio link quality assessed based on the each RS resource subgroup is worse than a first-type threshold, increases a first-type counter corresponding to the each RS resource subgroup by 1; determines whether to trigger a BFR based on whether the first-type counter corresponding to the each RS resource subgroup reaches a first-type value; receives a second signaling, the second signaling indicates a first uplink grant;

the first transmitter 1802 determines a format of the target MAC CE based on a number of RS resource subgroup(s) indicated by each of at least one candidate format in a first candidate format set, an RS resource subgroup indicated by any of the at least one candidate format in the first candidate format set is an RS resource subgroup in the first RS resource set; transmits the target MAC CE according to an instruction of the first uplink grant;

In embodiment 18, the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, under the condition of not exceeding a size of resources granted by the first uplink grant, the format of the target MAC CE is a candidate format containing a largest amount of BFR information in the at least one candidate format in the first candidate format set; a number of RS resource subgroup(s) indicated by any of the at least one candidate format in the first candidate format set is used to determine the amount of BFR information contained by the any candidate format.

In one embodiment, under the condition of not exceeding a size of resources granted by the first uplink grant, amounts of BFR information contained by at least two candidate formats in the at least one candidate format in the first candidate format set are tied for largest; the format of the target MAC CE is a candidate format with a largest number of RS resource subgroup(s) indicated in the at least two candidate formats; a number of RS resource subgroup(s) indicated by any of the at least one candidate format in the first candidate format set is used to determine the amount of BFR information contained by the any candidate format.

In one embodiment, under the condition of not exceeding a size of resources granted by the first uplink grant, the format of the target MAC CE is a candidate format occupying a largest number of octet(s) in the at least one candidate format in the first candidate format set, and a number of RS resource subgroup(s) indicated by any of the at least one candidate format in the first candidate format set is used to determine the number of octet(s) occupied by the any candidate format.

In one embodiment, under the condition of not exceeding a size of resources granted by the first uplink grant, numbers of octets occupied by at least two candidate formats in the at least one candidate format in the first candidate format set are tied for largest; the format of the target MAC CE is a candidate format containing a largest amount of BFR information in the at least two candidate formats; a number of RS resource subgroup(s) indicated by any of the at least one candidate format in the first candidate format set is used to determine the number of octet(s) occupied by the any candidate format.

In one embodiment, BFR information contained in any of the at least one candidate format in the first candidate format set belongs to first H RS resource subgroup(s) sorted according to a first criterion for RS resource subgroup(s) in the first RS resource set, and the first criterion comprises at least sorting according to a cell identity of an associated cell.

In one embodiment, any RS resource subgroup indicated by the first candidate format is indicated by the second candidate format, and at least one RS resource subgroup having BFR indicated by the second candidate format is not indicated by the first candidate format.

In one embodiment, the first receiver 1801 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1801 comprises the antenna 452, the receiver 454, the multi-antenna receiving processor 458 and the receiving processor 456 in FIG. 4 of the present application.

In one embodiment, the first receiver 1801 comprises the antenna 452, the receiver 454 and the receiving processor 456 in FIG. 4 of the present application.

In one embodiment, the first transmitter 1802 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1802 comprises the antenna 452, the transmitter 454, the multi-antenna transmitting processor 457 and the transmitting processor 468 in FIG. 4 of the present application.

In one embodiment, the first transmitter 1802 comprises the antenna 452, the transmitter 454 and the transmitting processor 468 in FIG. 4 of the present application.

### Embodiment 19

Embodiment 19 illustrates a structure block diagram of a processor in a second node according to one embodiment of the present application, as shown in FIG. 19. In FIG. 19, a processor 1900 of a second node comprises a second transmitter 1901 and a second receiver 1902.

The second transmitter 1901 transmits a first signaling, the first signaling indicates a first RS resource set, the first RS resource set comprises at least one RS resource group, each RS resource group in the at least one RS resource group is associated with a cell, each RS resource group in the at least one RS resource group comprises at least one RS resource subgroup, and each RS resource subgroup comprises at least one RS resource; transmits a second signaling, the second signaling indicates a first uplink grant;

the second receiver 1902 receives a target MAC CE;

in embodiment 19, for each RS resource subgroup in the first RS resource set, whenever radio link quality assessed based on the each RS resource subgroup is worse than a first-type threshold, a first-type counter corresponding to the each RS resource subgroup is increased by 1; whether to trigger a BFR is determined based on whether the first-type counter corresponding to the each RS resource subgroup reaches a first-type value; the target MAC CE is transmitted according to the instruction of the first uplink grant; a format of the target MAC CE is determined based on a number of RS resource subgroup(s) indicated by each of at least one candidate format in a first candidate format set, an RS resource subgroup indicated by any of the at least one candidate format in the first candidate format set is an RS resource subgroup in the first RS resource set; the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

In one embodiment, under the condition of not exceeding a size of resources granted by the first uplink grant, the format of the target MAC CE is a candidate format containing a largest amount of BFR information in the at least one candidate format in the first candidate format set; a number of RS resource subgroup(s) indicated by any of the at least one candidate format in the first candidate format set is used to determine the amount of BFR information contained by the any candidate format.

In one embodiment, under the condition of not exceeding a size of resources granted by the first uplink grant, amounts of BFR information contained by at least two candidate formats in the at least one candidate format in the first candidate format set are tied for largest; the format of the target MAC CE is a candidate format with a largest number of RS resource subgroup(s) indicated in the at least two candidate formats; a number of RS resource subgroup(s) indicated by any of the at least one candidate format in the first candidate format set is used to determine the amount of BFR information contained by the any candidate format.

In one embodiment, under the condition of not exceeding a size of resources granted by the first uplink grant, the format of the target MAC CE is a candidate format occupying a largest number of octet(s) in the at least one candidate format in the first candidate format set, and a number of RS resource subgroup(s) indicated by any of the at least one candidate format in the first candidate format set is used to determine the number of octet(s) occupied by the any candidate format.

In one embodiment, under the condition of not exceeding a size of resources granted by the first uplink grant, numbers of octets occupied by at least two candidate formats in the at least one candidate format in the first candidate format set are tied for largest; the format of the target MAC CE is a candidate format containing a largest amount of BFR information in the at least two candidate formats; a number of RS resource subgroup(s) indicated by any of the at least one candidate format in the first candidate format set is used to determine the number of octet(s) occupied by the any candidate format.

In one embodiment, BFR information contained in any of the at least one candidate format in the first candidate format set belongs to first H RS resource subgroup(s) sorted according to a first criterion for RS resource subgroup(s) in the first RS resource set, and the first criterion comprises at least sorting according to a cell identity of an associated cell.

In one embodiment, any RS resource subgroup indicated by the first candidate format is indicated by the second candidate format, and at least one RS resource subgroup having BFR indicated by the second candidate format is not indicated by the first candidate format.

In one embodiment, the second transmitter 1901 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1901 comprises the antenna 420, the transmitter 418, the multi-antenna transmitting processor 471 and the transmitting processor 416 in FIG. 4 of the present application.

In one embodiment, the second transmitter 1901 comprises the antenna 420, the transmitter 418 and the transmitting processor 416 in FIG. 4 of the present application.

In one embodiment, the second receiver 1902 comprises the antenna 420, the receiver 418, the multi-antenna receiving processor 472, the receiving processor 470, the controller/processor 475 and the memory 476 in FIG. 4 of the present application.

In one embodiment, the second receiver 1902 comprises the antenna 420, the receiver 418, the multi-antenna receiving processor 472 and the receiving processor 470 in FIG. 4 of the present application.

In one embodiment, the second receiver 1902 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource; for each RS resource subgroup in the first RS resource set, whenever radio link quality assessed based on the each RS resource subgroup is worse than a first-type threshold, increasing a first-type counter corresponding to the each RS resource subgroup by 1; determining whether to trigger a BFR based on whether the first-type counter corresponding to each RS resource subgroup reaches a first-type value; receiving a second signaling, the second signaling indicating a first uplink grant; and
a first transmitter, determining a format of a target MAC CE based on a number of RS resource subgroup(s) indicated by each of at least one candidate format in a first candidate format set, an RS resource subgroup indicated by any of the at least one candidate format in the first candidate format set being an RS resource subgroup in the first RS resource set; transmitting the target MAC CE according to an instruction of the first uplink grant;
wherein the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

2. The first node according to claim 1, wherein BFR information contained in any of the at least one candidate format in the first candidate format set belongs to first H RS resource subgroup(s) sorted according to a first criterion for RS resource subgroup(s) in the first RS resource set, and the first criterion comprises at least sorting according to a cell identity of an associated cell.

3. The first node according to claim 1, wherein any RS resource subgroup indicated by the first candidate format is indicated by the second candidate format, and at least one RS resource subgroup having BFR indicated by the second candidate format is not indicated by the first candidate format.

4. The first node according to claim 1, wherein a candidate format in the first candidate format set comprises candidate format A9; the candidate format A9 comprises a second bitmap with a size equal to 1 byte and a third bitmap with a size equal to 1 byte, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, the candidate format A9 comprises BFR information associated with each of the at least one RS resource subgroup.

5. The first node according to claim 1, wherein a candidate format in the first candidate format set comprises candidate format A10; the candidate format A10 comprises a second bitmap with a size equal to 4 bytes and a third bitmap with a variable size, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, the candidate format A10 comprises BFR information associated with each of the at least one RS resource subgroup.

6. The first node according to claim 1, wherein a candidate format in the first candidate format set comprises candidate format A11; the candidate format A11 comprises a second bitmap with a size equal to 1 byte and a third bitmap with a size equal to 1 byte, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, whether the candidate format A11 comprises BFR information associated with each of the at least one RS resource subgroup is related to a size of resources granted by the first uplink grant.

7. The first node according to claim 1, wherein a candidate format in the first candidate format set comprises candidate format A12; the candidate format A12 comprises a second bitmap with a size equal to 4 bytes and a third bitmap with a variable size, one field in the second bitmap is used to indicate whether there exists at least one RS resource subgroup having BFR in an RS resource group determined by the field, and one field in the third bitmap is used to indicate whether there exists an RS resource subgroup without BFR in the RS resource group; if the field in the second bitmap and the field in the third bitmap indicate that there exists at least one RS resource subgroup having BFR in the RS resource group, whether the candidate format A12 comprises BFR information associated with each of the at least one RS resource subgroup is related to a size of resources granted by the first uplink grant.

8. The first node according to claim 1, wherein the target MAC CE consists of a second bitmap and a third bitmap.

9. The first node according to claim 1, wherein the target MAC CE consists of a second bitmap, a third bitmap and at least one BFR information.

10. The first node according to claim 4, wherein a number of bits set to 1 in the second bitmap is used to determine a size of the third bitmap.

11. The first node according to claim 4, wherein significant bits of the third bitmap are sorted in an ascending order according to cell ID(s) of cell(s) associated with bit(s) set to 1 in the second bitmap.

12. The first node according to claim 4, wherein one bit in the second bitmap is used to indicate whether an RS resource group corresponding to the bit comprises an RS resource subgroup having BFR; another bit in the third bitmap is used to indicate whether an RS resource group corresponding to the bit in the second bitmap comprises an RS resource subgroup without BFR.

13. The first node according to claim 4, wherein if an RS resource group comprises an RS resource subgroup having BFR, set a bit corresponding to the RS resource group in the second bitmap to 1; otherwise set it to 0; if the RS resource group does not comprise an RS resource subgroup without BFR, set a bit corresponding to the RS resource group in the third bitmap to 1, otherwise set it to 0.

14. The first node according to claim 4, wherein the second bitmap comprises a second specific field, the third bitmap comprises a third specific field, and at least a former in the second specific field or the third specific field indicates the SpCell.

15. The first node according to claim 1, wherein the BFR information comprises at least a first MAC field and a second MAC field; the first MAC field in the BFR information indicates whether the second MAC field in the BFR information exists; if the first MAC field in the BFR information indicates an existence of the second MAC field in the BFR information, and the second MAC field in the BFR information indicates a candidate RS resource, and the candidate RS resource is associated with the RS resource subgroup corresponding to the BFR information; if the first MAC field in the BFR information indicates that the second MAC field in the BFR information does not exist, the second MAC field in the BFR information is reserved.

16. The first node according to claim 1, wherein the BFR information consists of the first MAC field, the second MAC field, and the third MAC field; the third MAC field is reserved.

17. The first node according to claim 1, wherein the BFR information consists of the first MAC field, the second MAC field, and the third MAC field; the third MAC field is used to indicate an RS resource subgroup corresponding to the BFR information.

18. The first node according to claim 1, wherein the BFR information occupies an octet; a length of the first MAC field is equal to 1 bit, a length of the second MAC field is equal to 6 bits, and a length of the third MAC field is equal to 1 bit; the first MAC field is located before the third MAC field, and the third MAC field is located before the second MAC field.

19. A second node for wireless communications, comprising:
a second transmitter, transmitting a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource; transmitting a second signaling, the second signaling indicating a first uplink grant; and
a second receiver, receiving a target MAC CE;
wherein for each RS resource subgroup in the first RS resource set, whenever radio link quality assessed based on the each RS resource subgroup is worse than a first-type threshold, a first-type counter corresponding to the each RS resource subgroup is increased by 1; whether to trigger a BFR is determined based on whether the first-type counter corresponding to each RS resource subgroup reaches a first-type value; the target MAC CE is transmitted according to the instruction of the first uplink grant; a format of the target MAC CE is determined based on a number of RS resource subgroup(s) indicated by each of at least one candidate format in a first candidate format set, an RS resource subgroup indicated by any of the at least one candidate format in the first candidate format set is an RS resource subgroup in the first RS resource set; the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.

20. A method in a first node for wireless communications, comprising:
receiving a first signaling, the first signaling indicating a first RS resource set, the first RS resource set comprising at least one RS resource group, each RS resource group in the at least one RS resource group being associated with a cell, each RS resource group in the at least one RS resource group comprising at least one RS resource subgroup, each RS resource subgroup comprising at least one RS resource;
for each RS resource subgroup in the first RS resource set, whenever radio link quality assessed based on the each RS resource subgroup is worse than a first-type threshold, increasing a first-type counter corresponding to the each RS resource subgroup by 1; determining whether to trigger a BFR based on whether the first-type counter corresponding to each RS resource subgroup reaches a first-type value;
receiving a second signaling, the second signaling indicating a first uplink grant; and
determining a format of a target MAC CE based on a number of RS resource subgroup(s) indicated by each of at least one candidate format in a first candidate format set, an RS resource subgroup indicated by any of the at least one candidate format in the first candidate format set being an RS resource subgroup in the first RS resource set; transmitting the target MAC CE according to an instruction of the first uplink grant;
wherein the format of the target MAC CE is one format in the first candidate format set, each candidate format in the first candidate format set is a format of a MAC CE used to indicate BFR, and the first candidate format set comprises at least a first candidate format and a second candidate format; the first candidate format and the second candidate format are different.
